(19) United States
(12) Patent Application Publication
(10) Pub. No.: US 2026/0330349 A1
(43) Pub. Date: Oct. 22, 2026

(54) SYSTEM

(71) Applicant: SoftBank Group Corp., Tokyo (JP)

(72) Inventor: Megumi NAGANO, Tokyo (JP)

(73) Assignee: SoftBank Group Corp., Tokyo (JP)

(21) Appl. No.: 19/649,158

(22) Filed: Apr. 16, 2026

(30) Foreign Application Priority Data
Apr. 22, 2025 (JP) 2025-070976

(51) Int. Cl. G06Q 10/0631; G06Q 10/0639

(52) U.S. Cl. CPC G06Q 10/063114; G06Q 10/06315; G06Q 10/06393

(57) ABSTRACT

The present invention relates to a project management system utilizing generative AI, wherein a task progress monitoring unit automatically extracts a task progress and a risk in real time, a personnel allocation optimization unit analyzes a skill, a workload, and past performance of each member and automatically determines optimal task allocation and prioritization, a progress report generation unit automatically generates a report summarizing a progress, a problem, and a risk and distributes the report to a person concerned, a resource management optimization unit performs resource allocation such as budget, personnel, and time, and risk determination, and a past data comparative analysis unit realizes trend prediction and an optimal operation proposal by comparative analysis with a past project, thereby centrally and efficiently automating progress management, personnel adjustment, resource optimization, and risk management of an entire project, reducing a burden of project operation, and improving a success probability.

### CROSS-REFERENCE TO RELATED APPLICATION

The present application claims priority to and incorporates by reference the entire contents of Japanese Patent Application No. 2025-070976 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

A problem to be solved by the present invention is the complexity of progress management of an entire project faced by a project manager, a team leader, and a corporate manager, the enormous effort required to optimize personnel allocation and task prioritization, the imbalance of resource (budget, time, and personnel) allocation, the delay and discrepancy of information transmission due to lack of communication inside and outside a team, the delay and quality deterioration of the project caused by these, and the point that trend prediction and risk management become dependent on individual skills and inefficient because past project data cannot be sufficiently utilized. Therefore, in order to solve these problems, the present invention aims to significantly reduce human burden and risk in project operation and to improve smooth execution and success probability of the project by monitoring a task progress status in real time utilizing generative AI, automating optimal personnel allocation and task prioritization after analyzing a skill and a workload status of each team member, periodically and automatically presenting a progress report, a problem, and risk information to an internal chat tool or a dashboard, and further centrally and efficiently realizing management and optimization of project resources, and trend prediction and risk management by comparative analysis with past project data.

### SUMMARY OF THE INVENTION

A means for solving the problem according to the present invention constitutes a project management system comprising a task progress monitoring unit, a personnel allocation optimization unit, a progress report generation unit, a resource management optimization unit, and a past data comparative analysis unit, wherein the task progress monitoring unit monitors a progress status of each task in a project in real time using generative AI, automatically detects a state change and a progress degree of the task, and acquires progress data; the personnel allocation optimization unit analyzes the progress data and a skill set, a workload, and past performance information of each team member by the generative AI, automatically determines optimal personnel allocation and task prioritization, and performs task reallocation and personnel adjustment as necessary; the progress report generation unit automatically generates a progress report, a problem, and risk information periodically using the generative AI based on output results of the task progress monitoring unit and the personnel allocation optimization unit, and presents the generated progress report, problem, and risk information to an internal chat tool or a dedicated dashboard; the resource management optimization unit analyzes resource information such as an overall project budget, remaining time, and the number of personnel by the generative AI, and automatically performs optimization of resource allocation, risk determination of delivery delay and budget overrun, and proposal of additional personnel and cost reduction; and the past data comparative analysis unit comparatively analyzes past project data and a progress and resource consumption status of a current project by the generative AI, and outputs information supporting trend prediction and risk management, thereby centrally and efficiently realizing progress management, personnel allocation, task prioritization, resource optimization, and risk management of the entire project.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

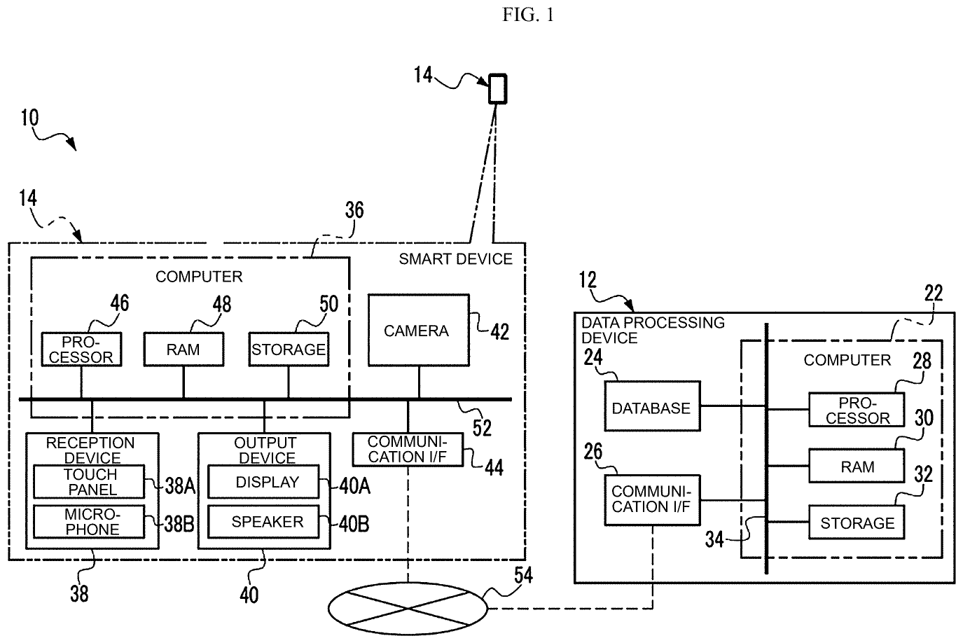

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

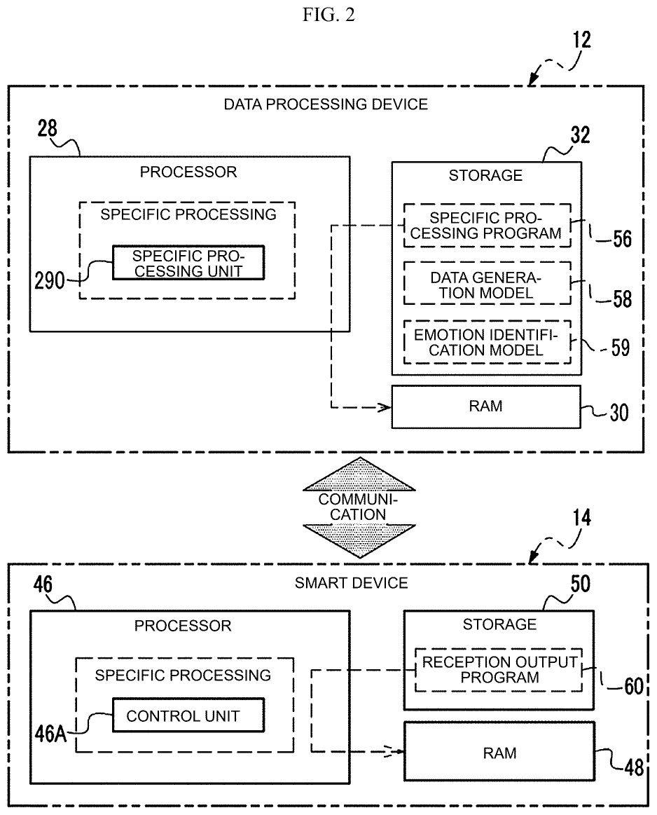

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

An embodiment of the present invention will be described more specifically and in detail. The project management system of the present invention is composed of a server and a terminal, and functions of respective units are mainly realized on the server side, but a user interface, notification, input reception, and the like are realized on the terminal side. Hereinafter, an extremely comprehensive and specific description will be given, including the configuration of each unit, a utilization method of generative AI, role sharing between the server and the terminal, specific usage examples, operation scenarios, response to abnormality, scalability, security, operation management, introduction patterns, and the like. Specifically, the present system adopts a distributed computing architecture. The present system arranges a parallel computing cluster composed of a plurality of computing nodes on the server side. The present server hosts a plurality of artificial intelligence models such as a large language model and a time series analysis model. The present terminal executes a lightweight front-end application. The present system uses a secure bidirectional communication protocol for communication between the server and the terminal. The present system transmits input data from the terminal to the server in real time. The present server expands the received data into a tensor space on a memory. The present server inputs the expanded tensor data to the artificial intelligence model. The present artificial intelligence model executes a matrix operation in a high-dimensional space. The present artificial intelligence model outputs an inference score and a generated text as an operation result. The present server post-processes the output result with an optimization algorithm. The present server returns the post-processed data to the terminal. The present terminal asynchronously draws the received data on the user interface. The present system executes this series of processing with a low latency in milliseconds. The present system completely eliminates data aggregation and analysis work by human manual operation. The present system dramatically improves the processing speed and memory usage efficiency of a computer. The present system converts a complex business process of project management into a data-driven automated process. The present system is applied to a wide range of fields such as software development and construction projects. The present system detects a delay risk of a project at an early stage. The present system dynamically executes optimal resource allocation. The present system increases a success probability of the project at a statistically significant level. The present system receives a multidimensional vector including various indicators of the project as input data. The present system executes complementation of missing values and normalization as preprocessing of the input data. The present system inputs the preprocessed data to the artificial intelligence model. The present artificial intelligence model outputs a score indicating the health of the project. The present system automatically triggers subsequent warning issuance processing and resource reallocation processing based on this score. The present system thereby strongly supports a decision of an administrator.

First, the task progress monitoring unit is realized on the server, cooperates with a plurality of internal and external systems such as a project management tool, a task management system, a version management system, a man-hour management system, a communication tool, a mail system, and a calendar system through an API, a Webhook, an RPA, batch processing, and the like, and collects progress status data of each task in real time or periodically. For example, diverse data is collected, such as a start date and time of a task, a scheduled completion date, an actual completion date, a person in charge, a progress rate, work contents, contents of a comment field, an attached file, related minutes, a failure report, a risk report, an approval history, a change history, a dependency relationship with other related tasks, priority, urgency, a task type (design, implementation, test, review, release, maintenance, etc.), a scale and difficulty of the task, a man-hour estimate, a frequency of a progress report, contents of the progress report, a delay status of the progress report, and a tone and an emotion analysis result of a comment of the person in charge. The generative AI analyzes these progress data and comment contents using technologies such as natural language processing, emotion analysis, abnormality detection, point extraction, topic classification, keyword extraction, and time series analysis, automatically extracts situations such as, for example, “progress is significantly delayed”, “person in charge does not understand task contents”, “priority of task is incorrect”, “there is contradiction in dependency relationship of tasks”, “failures occur frequently”, “communication is insufficient”, and “person in charge feels excessive stress”, and classifies the state of the task into “normal”, “requiring attention”, “having risk”, “abnormal”, and the like. For example, when the progress report has not been submitted for a certain period of time, or when keywords such as “delay”, “failure”, “resource shortage”, “unknown”, “confusion”, “difficulty”, “readjustment”, and “re-estimation” frequently appear in the comment field, the generative AI detects this and automatically determines the state of the task as “requiring attention” or “having risk”. Furthermore, for example, it is also possible to detect a complex risk by combining a plurality of abnormal patterns, such as when the progress rate of the task rapidly decreases, when the person in charge is frequently changed, or when failures occur frequently in related tasks. Specifically, the present task progress monitoring unit integrates the collected diverse data to generate a multimodal input tensor. The present monitoring unit executes morphological analysis and word embedding processing on text data. The present monitoring unit executes zero-mean variance normalization on numerical data. The present monitoring unit combines these preprocessed data to construct, for example, a 768-dimensional feature vector. The present monitoring unit inputs this feature vector to a large language model and a long short-term memory network for time series analysis. Specific examples of the present input data include a numerical vector indicating that the progress rate is 45 percent, a text tensor obtained by vectorizing a comment that specifications are unclear, and a time series array indicating that the number of commits in the past three days is zero. The present artificial intelligence model executes an operation using a self-attention mechanism in a high-dimensional space based on these input data. The present artificial intelligence model generates a risk probability distribution and an abnormality classification label of each task as output data. Specific examples of the present output data include a probability score indicating that the delay risk is 85 percent, a category label indicating a resource shortage, and an emotion score indicating that the stress level of the person in charge is high. The present monitoring unit transmits this output result to a subsequent threshold determination module. The present threshold determination module triggers alert generation processing when the risk probability exceeds a preset threshold. The present monitoring unit eliminates confirmation work by human visual inspection, and dramatically improves the speed and accuracy of abnormality detection. The present monitoring unit is applied to fields requiring strict progress management, such as early discovery of bugs in software development and prevention of process delays in the manufacturing industry. The present monitoring unit completely automates a pipeline from data collection to abnormality detection, and optimizes a communication load and computing resources of the entire system.

The personnel allocation optimization unit is realized on the server, acquires a skill set (possessed qualifications, years of experience, field of expertise, past assigned task, evaluation history, self-reported skill, external training history, language ability, leadership, communication ability, stress tolerance, available overtime hours, working style, remote availability, health condition, vacation schedule, desired work, past withdrawal rate, past failure response performance, etc.), a current workload (number of assigned tasks, total man-hours of ongoing tasks, overtime status, latest operation rate, operation performance in the past week, concurrent status with other projects, etc.), a working status (attendance/leaving information, telecommuting status, business trip schedule, vacation application, physical condition report, etc.), and past performance information (delivery compliance rate, quality evaluation, customer satisfaction, failure response history, project contribution degree, commendation history, trouble occurrence rate, etc.) of each team member from a database, and the generative AI analyzes these pieces of information using technologies such as multivariate analysis, clustering, pattern recognition, reinforcement learning, Bayesian inference, decision tree, and regression analysis. For example, when a certain member has strengths in “design” and “review” and has completed a similar task with high quality in the past, the generative AI preferentially allocates the member to the corresponding task. Also, for example, when a certain member is proceeding with a plurality of tasks simultaneously and the workload is high, the generative AI suppresses new task allocation to the member and automatically selects another suitable person. Furthermore, for example, the priority of the task is dynamically changed according to the progress status and resource status of the project, and task reallocation and an increase/decrease in personnel are proposed as necessary. For example, when a delay occurs in a design process, the generative AI confirms an availability status of another member having a design skill and proposes additional allocation. For example, when failures occur frequently in a test process, a member having abundant failure response experience in the past is preferentially allocated. For example, when a new task is added in the middle of the project or when the skill set of the member is updated, the generative AI immediately recalculates the overall task allocation and resource allocation, and automatically generates an optimal operation plan. Specifically, the present personnel allocation optimization unit converts the acquired member information into a multidimensional skill matrix tensor. The present optimization unit encodes requirement specifications of the task as a task feature vector. The present optimization unit inputs these tensor data to a graph neural network and a reinforcement learning agent. Specific examples of the present input data include a numerical vector indicating years of experience in a specific programming language, a time series array indicating remaining man-hours of currently held tasks, and a categorical tensor encoding a past failure response history. The present artificial intelligence model executes an inner product operation and a non-linear transformation for calculating a matching degree between the member and the task. The present artificial intelligence model generates an allocation probability distribution of the task to each member and an optimization score as output data. Specific examples of the present output data include a score indicating that a probability that member A completes task B within a deadline is 92 percent, an evaluation index indicating a load distribution degree of the entire team, and structured data indicating a recommended combination of task allocation. The present optimization unit transmits this output result to a subsequent allocation update module. The present allocation update module selects an allocation plan with the highest score, and automatically rewrites task person-in-charge information on the database. The present optimization unit eliminates inefficient personnel allocation depending on human intuition and experience. The present optimization unit maximizes productivity of the entire project by exhaustive search and an optimization algorithm by a computer. The present optimization unit is applied to fields requiring complex resource management, such as a large-scale system development project and a construction site involving a large number of workers. The present optimization unit executes recalculation in real time in response to a dynamic environmental change, and always maintains an optimal state.

The progress report generation unit is realized on the server, and automatically generates a progress report periodically using the generative AI based on data obtained from the task progress monitoring unit and the personnel allocation optimization unit. For example, at an arbitrary timing such as daily, weekly, or monthly, a report is created including an assigned task, a progress rate, a workload, a detected problem, risk information, a resource consumption status, a delivery compliance status, a budget consumption rate, the number of failure occurrences, a quality evaluation, feedback from a customer, an important change history, a future issue, a next action item, and the like for each team member. The generative AI automatically generates a text summarizing a situation in an easy-to-understand manner using a natural language generation technology, instead of mere numerical values or a list, such as “Currently, Mr. A is in charge of the design task, and the progress is 80%, but it is determined that the risk is high because there is a description in the comment field that ‘delay is expected due to the influence of specification change’” and “Mr. B is in charge of the test process, and the number of failures is on an increasing trend, so additional quality management is necessary”. Furthermore, for example, when a particularly important problem or risk information is detected in the progress report, the generative AI highlights them so that a project manager or a team leader can respond immediately. For example, based on contents of the progress report, the generative AI can also propose a specific action plan such as “delivery delay risk will increase unless additional personnel are introduced within this week”, “outsourcing of test process should be considered”, and “re-estimation of related tasks is necessary due to specification change in design process”. These progress reports are automatically distributed from the server to the terminal (PC, smartphone, tablet, etc.) through an internal chat tool or a dedicated dashboard. For example, distribution can be performed by combining a plurality of notification means such as a group chat or an individual chat of the chat tool, a notification field of the dashboard, an email notification, a push notification, and calendar linkage. Specifically, the present progress report generation unit converts the collected various data into a structured JSON format payload. The present generation unit embeds this payload into a prompt template to construct an input text stream to the large language model. Specific examples of the present input data include numerical data indicating that the progress rate of the entire project is 65 percent, a text array indicating an outline of a failure that occurred in a specific task, and flag information indicating that the budget consumption rate exceeds an assumption. The present artificial intelligence model executes autoregressive token generation processing based on the input context. The present artificial intelligence model generates a report text described in a natural language, a metadata tag indicating an importance degree, and a list of recommended action plans as output data. Specific examples of the present output data include a summary paragraph warning of a delay risk, a specific text proposing introduction of additional personnel, and a structured text to which an HTML tag for highlighting is added. The present generation unit transmits this output result to a subsequent distribution routing module. The present distribution routing module converts the output text according to a format of each notification channel, and push-transmits the converted text to a terminal of a target user. The present generation unit completely reduces time for a human to manually create a report. The present generation unit ensures homogenization and objectivity of report contents, and prevents a delay in information transmission. The present generation unit realizes smooth information sharing in a distributed team mainly engaged in remote work or a large-scale project involving a large number of stakeholders. The present generation unit provides advanced insight understanding a context, instead of a mere enumeration of data, by utilizing a natural language processing technology.

The resource management optimization unit is realized on the server, and the generative AI analyzes resource information such as an overall project budget, remaining days, the number of personnel, an operation rate, a cost consumption status, an outsourcing cost, a capital investment, a license cost, a transportation cost, a business trip cost, an education cost, an overtime cost, a progress pace, a task consumption rate, and a resource allocation status. For example, the number of days and cost required until project completion are predicted from the number of remaining tasks and assumed man-hours of each task, and compared with a current budget and schedule. The generative AI automatically determines risks such as, for example, “delivery delay is expected at current progress pace”, “budget consumption is faster than assumed”, “personnel are insufficient in specific process”, “outsourcing cost is swelling”, and “education cost is insufficient”, and proposes introduction of additional personnel and a cost reduction measure. For example, the generative AI automatically generates a specific action plan such as “delivery delay risk can be reduced by additionally allocating two persons to test process”, “cost reduction is possible by considering outsourcing of design process”, and “quality improvement can be expected by increasing education cost and strengthening new employee education”, and presents the specific action plan to a project manager. Furthermore, for example, it is also possible to generate a plurality of patterns of optimization plans for resource allocation and present simulation results. Specifically, the present resource management optimization unit aggregates various cost indicators and progress data as a multidimensional time series tensor. The present optimization unit inputs this tensor data to a regression analysis model and a Monte Carlo simulation engine. Specific examples of the present input data include a numerical array indicating a daily budget consumption amount for the past one month, vector data indicating remaining assumed man-hours of each task, and time series data indicating a fluctuation history of the outsourcing cost. The present artificial intelligence model executes an operation of probabilistically predicting a future cost transition and a scheduled completion date based on these input data. The present artificial intelligence model generates a probability distribution of a predicted final cost, an occurrence probability of a delivery delay, and a simulation result based on a plurality of resource allocation scenarios as output data. Specific examples of the present output data include a score indicating that a budget overrun probability is 75 percent, date data indicating a scheduled completion date when two persons are added to the test process, and a structured list of action plans having the highest cost reduction effect. The present optimization unit transmits this output result to a subsequent dashboard drawing module. The present dashboard drawing module dynamically generates a graph and a chart based on the received data, and displays them on a terminal of an administrator. The present optimization unit realizes data-driven budget management that does not rely on human intuition. The present optimization unit solves a resource allocation problem in which complex variables are intertwined at high speed using computing capability of a computer. The present optimization unit is applied to public works with strict budget constraints, system integration business in which management of a profit margin is important, and the like. The present optimization unit makes it possible to instantly compare and examine a plurality of scenarios, and minimizes a financial risk of the project.

The past data comparative analysis unit is realized on the server, extracts a progress status, resource consumption, an occurred problem, a risk response history, a delivery compliance rate, a quality evaluation, customer satisfaction, the number of failure occurrences, a task allocation pattern, a resource allocation pattern, a success factor, a failure factor, an external environmental factor, a project scale, a period, a member configuration, a used technology, an outsourcing status, and the like of a similar project from a past project database, and the generative AI performs comparative analysis with a current project. For example, trends such as “design process was delayed by 10 days on average”, “bugs occurred frequently in test process”, “outsourcing cost exceeded budget”, and “lack of education for new members caused quality deterioration” in past projects are extracted, and when the current project shows a similar trend, the generative AI automatically generates a prediction and a warning such as “delay risk of design process is high”, “additional quality management is necessary in test process”, “management of outsourcing cost should be strengthened”, and “new employee education program should be implemented early”. Furthermore, for example, it is also possible to learn a pattern of resource allocation and task allocation in a past successful project, and propose an optimal operation method for the current project. For example, by extracting characteristics of a project having a high delivery compliance rate in the past and applying them to the current project, a success probability can be increased. Specifically, the present past data comparative analysis unit converts attribute information of a past project group and the current project into high-dimensional feature vectors, respectively. The present analysis unit inputs this vector data to a cosine similarity calculation algorithm and a clustering model. Specific examples of the present input data include a numerical vector indicating a scale and a period of the project, a categorical array encoding a used technology stack, and a tensor obtained by vectorizing a text description of a failure that occurred in the past. The present artificial intelligence model calculates a distance between the current project and the past project in a high-dimensional space, and specifies a similar project group. The present artificial intelligence model generates a list of similarity scores, structured data of risk factors extracted from past failure cases, and a set of recommended parameters based on success cases as output data. Specific examples of the present output data include a score indicating that a matching degree with a past similar project is 88 percent, numerical data indicating a delay probability in the design process, and a parameter value indicating a recommended ratio of test personnel. The present analysis unit transmits this output result to a subsequent risk evaluation module. The present risk evaluation module collates the extracted risk factors with a situation of the current project, and generates a specific warning message. The present analysis unit formalizes tacit knowledge accumulated in an organization, and realizes automatic knowledge extraction by a computer. The present analysis unit systematically prevents a human error peculiar to humans of repeating past failures. The present analysis unit is applied to fields with high uncertainty, such as launch of a new business and a research and development project including an unknown technical element. The present analysis unit finds a hidden pattern difficult for a human to discover from a huge amount of history data, and dramatically improves accuracy of project management.

On the terminal side, a user interface function is mainly realized. For example, a project manager, a team leader, and each member can browse and confirm a progress status, task allocation, resource allocation, risk information, proposal contents from the generative AI, and the like in real time from a terminal such as a PC, a smartphone, or a tablet through a dashboard screen or a chat tool. For example, on the dashboard screen, a progress graph of the entire project, a task list, a progress status by person in charge, a resource consumption status, a risk list, a comparison graph with past data, proposal contents from the generative AI, an action item list, a notification history, a comment field, a file attachment field, and the like are displayed. Furthermore, for example, when an operation such as task progress update, comment input, resource application, problem report, risk report, approval operation, task allocation change, schedule adjustment, meeting convocation, file upload, or chat transmission is performed on the terminal side, the information is immediately reflected on the server side, and analysis and optimization processing by the generative AI are automatically re-executed. For example, in the chat tool, the generative AI can automatically post a progress report and a risk warning, and perform an FAQ automatic response to a question from a user. Specifically, the application on the present terminal side is constructed using a lightweight front-end framework. The present terminal captures an event such as a tap operation or text input by a user, and generates a JSON payload for asynchronous communication. The present terminal transmits this payload to an API endpoint on the server side via a secure communication protocol. Specific examples of the present input data include numerical data for updating the progress rate of the task, a character string of a question text input to the chat tool, and binary data of an uploaded file. The present server-side system immediately writes the received data to a database, and triggers inference processing of a related artificial intelligence model. The present artificial intelligence model executes recalculation based on the input latest data, and generates updated drawing data for the dashboard and a response text from a chatbot as output data. Specific examples of the present output data include date data of a recalculated scheduled project completion date, a natural language text presenting a solution to a user's question, and a coordinate array for graph drawing. The present terminal receives this output result from the server, and redraws only a corresponding part of the screen at high speed using a virtual DOM technology. The present terminal updates the user interface without accompanying reloading of the entire screen, and provides extremely smooth operability. The present terminal realizes real-time information synchronization while minimizing consumption of a network bandwidth. The present terminal is particularly effective in a use case assumed to be used in a mobile environment, such as a construction site or a sales representative on the move. The present terminal functions as a seamless interactive interface between a user and artificial intelligence, and significantly improves business efficiency.

Also, for example, the generative AI can utilize a combination of diverse AI technologies, such as semantic analysis of task contents and comments by natural language processing, abnormality detection, point extraction, priority determination, risk prediction, automatic generation of a progress report, automatic proposal of a resource allocation plan, pattern matching with past data, FAQ automatic response regarding project operation, automatic summarization of minutes, automatic minute creation of meeting contents, automatic classification of failure reports, automatic visualization of task dependency relationships, calculation of a health score of the entire project, motivation analysis of members, stress detection, automatic generation of a burndown chart and a Gantt chart, automatic specification of a progress delay factor, automatic generation of a risk scenario, resource optimization among a plurality of projects, and automatic response proposal to an external environmental change (law revision, disaster, pandemic, etc.). For example, a large language model can be used for text generation of the progress report, reinforcement learning and Bayesian inference can be applied to task allocation and resource optimization, an outlier detection algorithm can be applied to abnormality detection, clustering and regression analysis can be applied to past data analysis, an abstractive summarization model can be applied to point extraction, an emotion classification model can be applied to emotion analysis, and an interactive AI model can be applied to FAQ response. Specifically, the present system includes an ensemble learning architecture and a pipeline processing mechanism that integrate a plurality of specialized artificial intelligence models. The present system routes data to an appropriate model according to characteristics of input multimodal data. Specific examples of the present input data include a text array converted from voice recording data of a meeting, a time series tensor indicating an attendance log of a member, and a text vector regarding a law revision acquired from an external news site. The present system inputs these data to each model in parallel, and simultaneously executes inference processing. Each artificial intelligence model generates an inference result in each specialized area as output data. Specific examples of the present output data include a summary text of minutes, a continuous value score from 0 to 1 indicating a stress level of a member, and a probability distribution indicating an influence degree of an external environmental change on the project. The present system transmits these individual outputs to an integration module. The present integration module executes a final decision logic using an algorithm such as soft voting or weighted sum. The present system solves a complex composite task that cannot be handled by a single model by cooperative operation of a plurality of models. The present system dramatically improves inference accuracy and versatility of the entire system by combining fields of expertise of each model. The present system exhibits strong adaptive capability in project management under a dynamic and uncertain environment, such as a large-scale organizational restructuring or an unexpected market fluctuation. The present system seamlessly integrates diverse artificial intelligence technologies, and provides a next-generation intelligent business infrastructure.

Furthermore, for example, when a new task is added in the middle of the project or when the skill set of the member is updated, the generative AI immediately recalculates the overall task allocation and resource allocation, and automatically generates an optimal operation plan. For example, even when a sudden failure or trouble occurs, the generative AI can refer to a past similar case and present a prompt countermeasure and a risk avoidance plan. For example, when a member withdraws in the middle of the project, skills and loads of remaining members are re-evaluated, and task reallocation and utilization of an external resource are automatically proposed. For example, when a large-scale specification change occurs immediately before a delivery date, the generative AI automatically analyzes an influence range, and presents rescheduling and an additional resource introduction plan. For example, when a plurality of projects are managed simultaneously, it is also possible to cross-sectionally propose overall resource optimization and prioritization. Specifically, the present system implements an event-driven stream processing engine, and detects a state change in real time. The present system extracts only difference data triggered by an update event of a database, and inputs the difference data to the artificial intelligence model. Specific examples of the present input data include vector data indicating a required skill of a newly added task, a list array of tasks assigned to a withdrawn member, and a numerical tensor indicating an increase in man-hours accompanying a specification change. The present artificial intelligence model executes high-speed recalculation processing using these difference data and a memory network holding a current system state. The present artificial intelligence model generates an updated resource allocation tensor, a dependency relationship graph of affected tasks, and a structured text of a recommended recovery plan as output data. Specific examples of the present output data include a load score array of each member recalculated after member withdrawal, a list of critical paths expected to be delayed due to a specification change, and command data instructing personnel movement among a plurality of projects. The present system transmits this output result to a subsequent transaction management module. The present transaction management module updates allocation information while maintaining consistency of the database, and push-transmits an immediate notification to a terminal of a related person. The present system eliminates a time lag due to batch processing, and shortens a lead time from occurrence of an event to presentation of a countermeasure to milliseconds. The present system has extremely high affinity in an iterative project management method in which requirement changes frequently occur, such as agile development and scrum development. The present system improves resilience of the system against a dynamic environmental change, and prevents failure of the project.

In terms of security, access control, authentication and authorization, data encryption, log audit, unauthorized access detection, data backup, disaster countermeasure, and the like are implemented on the server side, and terminal authentication, session management, data encryption, remote lock, data erasure, and the like are implemented on the terminal side. For example, an access authority is finely set for each project to prevent leakage of confidential information and personal information. For example, regarding data handled by the generative AI, anonymization, masking, recording of an access log, clarification of a purpose of use, and the like are thoroughly performed. Specifically, the present system implements a multi-layered defense mechanism based on a zero trust architecture. The present system executes multi-factor authentication in response to a login request of a user, and issues a JSON web token having a temporary access authority. The present system encrypts all data on a communication path with a TLS protocol, and encrypts stored data in the database with an AES256 algorithm. The present system collects an access log and an operation history as time series data, and inputs them to an artificial intelligence model for abnormality detection. Specific examples of the present input data include a metadata array indicating an IP address and an access time of a user, a numerical vector indicating a calling frequency of an API, and text data immediately before being input to the artificial intelligence model. The present artificial intelligence model calculates a deviation degree from a normal behavior pattern based on these input data. The present artificial intelligence model generates a threat score and an abnormality classification label as output data. Specific examples of the present output data include a probability value indicating that a possibility of unauthorized access is 95 percent, an alert flag indicating mass download of data, and an index array of a text area including personal information requiring masking processing. The present system transmits this output result to a subsequent security control module. The present security control module automatically executes forced disconnection of a corresponding session and lockout of an account when the threat score exceeds a threshold. The present system also automatically masks a proper noun and personal information in text data using a regular expression and a named entity extraction model before being input to the artificial intelligence model. The present system eliminates an information leakage risk at a system level, and strictly satisfies compliance requirements. The present system enables use in an industry requiring an extremely high security standard, such as a financial institution and a medical institution. The present system automates security operation, and significantly reduces a monitoring burden on an administrator.

In terms of operation management, a system administrator can centrally manage operation statuses of the server and the terminal, a learning status of an AI model, a capacity of a database, an API cooperation status, a failure occurrence status, an inquiry status from a user, and the like on a dashboard. For example, when the accuracy of the AI model decreases, relearning can be automatically executed, and when a failure occurs, the administrator can be automatically notified. For example, system version upgrades and function additions can also be centrally managed and distributed on the server side. Specifically, the present system constantly monitors an operation state of each microservice using container orchestration technology. The present system collects metrics data such as a CPU usage rate, a memory consumption amount, and network traffic of each container in a time-series database. The present system calculates a deviation between an inference result of the artificial intelligence model and an actual project result, and monitors performance degradation of the model. The present system inputs these monitoring data to a control module of a continuous learning pipeline. Specific examples of the input data include a numerical array indicating an inference error for the past one week, precision and recall scores in a specific task classification, and a time-series tensor indicating latency of the entire system. The control module executes an algorithm for determining necessity of relearning based on the input data. The control module generates, as output data, an activation flag of a relearning job, a scaling command instructing resource expansion, and an alert message indicating occurrence of a failure. Specific examples of the output data include a trigger signal for starting fine-tuning of a language model, an API request for automatically expanding a storage capacity of a database, and a failure notification text transmitted to a smartphone of the administrator. The present system automatically activates a relearning process in the background based on this output result, generates a new weight parameter, and seamlessly updates the model. The present system maintains highly accurate inference constantly adapted to the latest data while keeping system downtime to zero. The present system automates most of operation and maintenance work, and dramatically reduces an operation cost of an IT infrastructure. The present system guarantees availability and reliability of the system at the highest level in a large-scale enterprise environment.

As an introduction pattern, various forms such as an in-house server installation type, a cloud service type, and a hybrid type can be supported. For example, the in-house server installation type can be selected when security requirements are strict, the cloud service type can be selected when scalability and external cooperation are emphasized, and the hybrid type can be selected when cooperation with an existing system is emphasized. For example, functions of respective units and the AI model can be customized according to a project scale, an industry type, and business contents. Specifically, the present system adopts a technology for managing an infrastructure as code, and completely automates a deployment process. The present system dynamically generates an environment setting file based on customer requirements. The present system inputs this setting file to a deployment engine. Specific examples of the input data include structured data in a YAML format indicating a network topology of an on-premises environment, a parameter array specifying an instance type of a cloud provider, and a JSON array indicating a list of artificial intelligence models to be activated. The deployment engine executes a series of processes such as pulling a container image, setting network routing, and provisioning a storage based on the input settings. The deployment engine generates, as output data, a status code indicating an activation state of each service, an IP address of a load balancer, and a log message indicating completion of initialization. Specific examples of the output data include an HTTP 200 status indicating that all microservices have been normally activated, a connection character string of a database, and account information for an administrator. The present system transmits this output result to a subsequent health check module, and finally confirms normality of the entire system. The present system flexibly and quickly deploys the system to any environment without being bound by physical constraints of hardware. By combining with edge computing technology, the present system also enables local inference in an in-factory network or the like where communication delay is not allowed. The present system provides an architecture capable of easily customizing hyperparameters of the artificial intelligence model and a pipeline of feature engineering in accordance with a business process specific to a customer.

As described above, in the embodiment of the present invention, by executing various analysis and optimization processes centered on the generative AI on the server side and providing a user interface and a notification function on the terminal side, collection, analysis, optimization, reporting, proposal, abnormality response, operation management, security measures, and scalability securing of all information regarding project management are centrally and automatically realized, burdens on a project manager, a team leader, and each member are significantly reduced, and a success probability of a project can be dramatically improved. Specifically, the present system completely replaces a series of mental processes of data collection, aggregation, analysis, and report creation, which have been conventionally manually performed by humans, with high-speed arithmetic processing inside a computer. The present system grasps a state of the project with accuracy and speed exceeding human cognitive limits by combining parallel processing of multidimensional data and advanced pattern recognition by the artificial intelligence model. The present system realizes improvement of computer technology itself, such as differential data communication that optimizes consumption of a network bandwidth and optimization of tensor calculation that minimizes a memory usage amount. The present system redefines an abstract task of project management as an aggregate of deterministic and probabilistic algorithms having clear input data and output data. The present system secures fault tolerance and scalability of the entire system by adopting a microservice architecture in which respective modules are loosely coupled. The present system brings about specific technical effects of reducing a delay risk, optimizing a cost, and improving quality in execution of projects in all industrial fields such as software development, construction, manufacturing, and research and development. The present system permeates data-driven decision making throughout an organization, and sublimates success of the project into an inevitable process rather than a coincidence. The present system fundamentally strengthens competitiveness of a company as a next-generation intelligent project management infrastructure.

### System Configuration

The system according to the present embodiment includes a task progress monitoring unit, a personnel allocation optimization unit, a progress report generation unit, a resource management optimization unit, a past data comparative analysis unit, a user interface unit, a notification management unit, a security management unit, and an operation management unit. The task progress monitoring unit has a function of cooperating with a plurality of internal and external systems such as a project management tool, a task management system, a version management system, a man-hour management system, a communication tool, a mail system, and a calendar system through an API, a Webhook, batch processing, and the like, and collecting progress status data of each task in real time or periodically. For example, diverse data is collected, such as a start date and time of a task, a scheduled completion date, an actual completion date, a person in charge, a progress rate, work contents, contents of a comment field, an attached file, related minutes, a failure report, a risk report, an approval history, a change history, a dependency relationship with another related task, priority, urgency, a type of the task, a scale and difficulty of the task, a man-hour estimate, a frequency of a progress report, contents of the progress report, a delay status of the progress report, and a tone and an emotion analysis result of a comment of the person in charge. The task progress monitoring unit executes natural language processing and abnormality detection using a prompt sentence to the generative AI such as “Analyze the following task progress data and comment contents, and extract a progress delay and a risk factor. Since a task ID, a progress rate, a comment, a name of a person in charge, and a scheduled completion date are input, point out if there is a sign of delay or failure, and list tasks requiring attention.”, and performs automatic extraction of a progress abnormality and a risk. For example, when a progress report has not been submitted for a certain period of time, or when keywords such as “delay”, “failure”, and “resource shortage” frequently appear in the comment field, the task progress monitoring unit detects this and automatically determines a state of the task as “requiring attention” or “at risk”. Furthermore, a complex risk is detected by combining a plurality of abnormality patterns, such as when the progress rate of the task rapidly decreases, when the person in charge is frequently changed, or when failures frequently occur in related tasks. Specifically, the task progress monitoring unit integrates the collected heterogeneous mixed data to construct a multimodal input tensor. The monitoring unit inputs this tensor data to a natural language processing model and a time-series abnormality detection model. Specific examples of the input data include structured JSON data including a task ID and a progress rate, an integer array obtained by tokenizing a comment of a person in charge, and a time-series vector of floating-point numbers indicating past progress transition. The artificial intelligence model analyzes a context of text using a self-attention mechanism, and simultaneously predicts future progress using an autoregressive model of time-series data. The artificial intelligence model generates, as output data, a risk probability score of each task, a text label of an extracted risk factor, and categorical data indicating severity of an abnormality. Specific examples of the output data include a score indicating that a delay probability of task A is 92 percent, a metadata tag extracting a keyword of resource shortage, and a flag value indicating that a severity level is the highest. The monitoring unit transmits this output result to a subsequent rule engine. The rule engine extracts a task whose risk score exceeds a specified threshold, and automatically updates a status on a database. The monitoring unit completely eliminates monitoring work by human visual inspection, and dramatically shortens a lead time of abnormality detection from several days to several milliseconds. The monitoring unit discovers a potential bug or specification inconsistency at an early stage in a large-scale software development project, and minimizes a rework cost.

The personnel allocation optimization unit acquires information such as a skill set, possessed qualifications, years of experience, field of expertise, past assigned task, evaluation history, self-reported skill, external training history, language ability, leadership, communication ability, stress tolerance, available overtime hours, working style, remote availability, health condition, vacation schedule, desired work, past withdrawal rate, and past failure response performance of each team member from a database, performs multivariate analysis and pattern recognition using the generative AI, and automatically generates an optimal personnel allocation plan. For example, prompt sentences such as “Preferentially allocate a member who has high design skills and has completed a similar task with high quality in the past”, “Do not allocate a new task to a member who is simultaneously progressing a plurality of tasks, and prioritize a member who has free time”, “Allocate a member with abundant failure response experience to a test process”, and “When a delay occurs in a design process, check availability of another member having design skills and propose additional allocation” are given to the generative AI to realize personnel allocation comprehensively considering skills, a workload, past performance, a working status, and the like. For example, when a new task is added in the middle of a project or when a skill set of a member is updated, the generative AI immediately recalculates overall task allocation and resource allocation, and automatically generates an optimal operation plan. Specifically, the personnel allocation optimization unit maps attribute information of a member and requirement information of a task to high-dimensional vector spaces, respectively. The optimization unit inputs this vector data to a graph convolutional network and a reinforcement learning algorithm. Specific examples of the input data include a multidimensional array in which a skill level of each member is normalized in a range of 0 to 1, an adjacency matrix indicating a dependency relationship between tasks, and a binary tensor indicating a current task allocation state. The artificial intelligence model executes a policy gradient method that maximizes a reward function in order to search for optimal matching between a member and a task. The artificial intelligence model generates, as output data, an allocation probability matrix of a member for each task, a productivity prediction score of the entire team, and an estimated value of an overhead cost accompanying reallocation. Specific examples of the output data include a matrix element indicating that a probability of allocating member B to task C is 88 percent, a predicted value indicating that total man-hours until project completion are reduced by 15 percent, and a JSON object including a list of recommended allocation changes. The optimization unit transmits this output result to a subsequent approval workflow module. The approval workflow module presents the optimized allocation plan on a dashboard of an administrator, and enables application with one click. The optimization unit eliminates personnel allocation depending on personal intuition and experience, and realizes objective and overall optimal resource management based on data. The optimization unit instantaneously performs recalculation even for a dynamic environmental change such as sudden absence of a member or a specification change, and prevents stagnation of the project.

The progress report generation unit automatically generates a progress report periodically using the generative AI based on data obtained from the task progress monitoring unit and the personnel allocation optimization unit. For example, a prompt sentence such as “Create a progress report for a project manager based on the following task progress data, person in charge information, and risk information. Summarize points in an easy-to-understand manner, including a progress rate, a workload, a problem, a risk, a resource consumption status, a delivery compliance status, the number of failure occurrences, quality evaluation, feedback from a customer, an important change history, a future issue, and a next action item.” is given to the generative AI, and a report including an assigned task, a progress rate, a workload, a detected problem, risk information, a resource consumption status, a delivery compliance status, a budget consumption rate, the number of failure occurrences, quality evaluation, feedback from a customer, an important change history, a future issue, a next action item, and the like for each team member is created at an arbitrary timing such as daily, weekly, or monthly. For example, when a particularly important problem or risk is detected in the progress report, the generative AI highlights them so that the project manager or the team leader can immediately respond. For example, it is also possible to propose a specific action plan such as “A delivery delay risk increases unless additional personnel are introduced within this week”, “Outsourcing of a test process should be considered”, and “Re-estimation of a related task is necessary due to a specification change in a design process”. Specifically, the progress report generation unit aggregates various metrics extracted from a database as structured context data. The generation unit dynamically embeds this context data into a prompt template of a large language model to generate an input text stream. Specific examples of the input data include an array of key-value pairs indicating a progress rate of each task, a text list of extracted risk factors, and numerical data of a budget consumption rate. The artificial intelligence model analyzes the input context and constructs a human-readable sentence using a natural language generation algorithm. The artificial intelligence model generates, as output data, a report text formatted in a markdown format, metadata of a color code according to importance, and a bulleted list of proposed action items. Specific examples of the output data include a paragraph text describing a summary of the entire project, an HTML tag for highlighting a task with a high delay risk in red, and a specific proposal sentence prompting introduction of additional personnel. The generation unit transmits this output result to a subsequent document management system and a notification module. The notification module converts the generated report into a PDF file, and automatically transmits the PDF file to an email address of a related party. The generation unit reduces an enormous amount of manual work time required for report creation to zero, and provides an environment in which an administrator can concentrate on original decision-making work. The generation unit unifies a format of report contents, and dramatically improves comparison between projects and searchability of past data.

The resource management optimization unit causes the generative AI to analyze resource information such as an overall project budget, remaining days, the number of personnel, an operation rate, a cost consumption status, an outsourcing cost, a capital investment, a license cost, a transportation cost, a business trip cost, an education cost, an overtime cost, a progress pace, a task consumption rate, and a resource allocation status, and automatically generates an optimal resource allocation plan, risk determination, and a proposal of additional personnel and a cost reduction measure. For example, prompt sentences such as “Predict the number of days and cost required until project completion from the number of remaining tasks and assumed man-hours of each task, and compare them with a current budget and schedule”, “Present a plan for introducing additional personnel when a delivery delay is expected at a current progress pace”, “Propose a cost reduction measure when budget consumption is faster than assumed”, and “Present a review plan of an outsourcing scope when an outsourcing cost is expanding” are given to the generative AI, and it is also possible to generate a plurality of patterns of resource allocation optimization plans and present simulation results. For example, the generative AI automatically generates a specific action plan such as “A delivery delay risk can be reduced by additionally allocating two persons to a test process”, “Cost reduction is possible by considering outsourcing of a design process”, and “Quality improvement can be expected by increasing an education cost and strengthening new employee education”, and presents the specific action plan to a project manager. Specifically, the resource management optimization unit integrates financial data and progress data to construct a multidimensional time-series tensor. The optimization unit inputs this tensor data to a gradient boosting decision tree and a deep learning-based time-series prediction model. Specific examples of the input data include an array of floating-point numbers indicating a past weekly cost consumption amount, vector data indicating remaining man-hours of each task, and an integer value indicating the current number of operating personnel. The artificial intelligence model executes a regression calculation for predicting future cost transition and a scheduled completion date based on these input data. The artificial intelligence model generates, as output data, numerical data of a predicted final cost, a percentage value indicating a budget overrun probability, and a JSON object of a simulation result based on a plurality of resource allocation scenarios. Specific examples of the output data include a predicted value that a final cost exceeds a budget by 12 percent, date data of a scheduled completion date when two test personnel are added, and a specific task reallocation plan for reducing an outsourcing cost. The optimization unit transmits this output result to a subsequent dashboard drawing engine. The dashboard drawing engine dynamically generates a graph of a prediction curve and a scenario comparison table based on the received data, and displays them on a user interface. The optimization unit automates financial management of a project in which complex variables are intertwined, and completely eliminates calculation errors and oversights by humans. The optimization unit detects a sign of a budget overrun extremely early, and prevents occurrence of a fatal deficit project.

The past data comparative analysis unit extracts a progress status, resource consumption, an occurred problem, a risk response history, a delivery compliance rate, quality evaluation, customer satisfaction, the number of failure occurrences, a task allocation pattern, a resource allocation pattern, a success factor, a failure factor, an external environmental factor, a project scale, a period, a member configuration, a used technology, an outsourcing status, and the like of a similar project from a past project database, and the generative AI performs comparative analysis with a current project. For example, prompt sentences such as “When a design process was delayed by 10 days on average in a past project, compare it with progress of a design process of a current project and evaluate a delay risk”, “Learn patterns of resource allocation and task allocation in a past successful project, and propose an optimal operation method for a current project”, “Extract characteristics of a past failed project, and check whether there is a similar risk in a current project”, and “Extract characteristics of a project with a high delivery compliance rate, and apply them to a current project” are given to the generative AI to realize pattern matching with past data, trend analysis, risk prediction, success factor extraction, failure factor extraction, optimal operation proposal, and the like. Specifically, the past data comparative analysis unit encodes attribute information of a past project group and attribute information of a current project into high-dimensional feature vectors, respectively. The analysis unit inputs this vector data to a cosine similarity calculation module and a clustering algorithm. Specific examples of the input data include normalized numerical data indicating a budget scale of a project, an array obtained by one-hot encoding a programming language to be used, and a text embedding tensor obtained by vectorizing a past failure report. The artificial intelligence model calculates a distance between a current project and a past project in a high-dimensional space, and identifies a cluster of the most similar project. The artificial intelligence model generates, as output data, a list of similarity scores, text data of a risk factor extracted from a past failure case, and a set of recommended parameters based on a success case. Specific examples of the output data include a score indicating that a similarity with past project D is 85 percent, a warning message indicating that a specification change risk in a design process is high, and numerical data indicating a ratio of a recommended test period. The analysis unit transmits this output result to a subsequent risk evaluation engine. The risk evaluation engine collates the extracted risk factor with current metrics of the current project, and generates a specific alert. The analysis unit effectively utilizes an enormous amount of past data accumulated in an organization, and enables advanced risk management equivalent to that of a veteran even for an inexperienced administrator. The analysis unit systematically avoids a past failure pattern, thereby improving quality and a delivery compliance rate of a project at a statistically significant level.

The user interface unit provides a function capable of browsing and confirming a progress status, task allocation, resource allocation, risk information, proposal contents from the generative AI, and the like in real time from a terminal such as a PC, a smartphone, or a tablet through a dashboard screen or a chat tool. For example, a progress graph of the entire project, a task list, a progress status by person in charge, a resource consumption status, a risk list, a comparison graph with past data, proposal contents from the generative AI, an action item list, a notification history, a comment field, a file attachment field, and the like are displayed on the dashboard screen. The user interface unit receives operations such as task progress update, comment input, resource application, problem report, risk report, approval operation, task allocation change, schedule adjustment, meeting convocation, file upload, and chat transmission on the terminal side, and immediately reflects the information on the server side. Specifically, the user interface unit is implemented as a front-end application based on a reactive programming paradigm. The interface unit asynchronously captures an event such as a screen tap or a keyboard input by a user, and generates an API request payload in a JSON format. The interface unit transmits this payload to an endpoint on the server side via a WebSocket or HTTPS protocol. Specific examples of the input data include flag data for changing a status of a task to completion, a text character string typed in a chat input field, and binary data of an uploaded image file. The server-side system writes the received data in a database, and triggers an inference process of a related artificial intelligence model. The artificial intelligence model generates, as output data, updated state data for a dashboard and a response text from a chatbot. Specific examples of the output data include a coordinate array for redrawing a progress graph, a new warning message added to a risk list, and an updated JSON object of a task list. The interface unit receives this output result from the server, and redraws only a corresponding component on a screen in milliseconds using a differential update algorithm of a virtual DOM. The interface unit eliminates reloading of the entire screen, minimizes consumption of a network bandwidth, and provides an extremely responsive user experience. The interface unit seamlessly connects a user and complex artificial intelligence processing of a back end, and makes an advanced project management function available by an intuitive operation.

A notification management unit has a function of automatically distributing a progress report, a risk warning, a proposal content from generative AI, and the like to related parties by combining a plurality of notification means such as a group chat and an individual chat of a chat tool, a notification column of a dashboard, an email notification, a push notification, and calendar cooperation. For example, operations such as “immediately notify a person in charge and a project manager when a progress delay occurs”, “send a warning notification to all related parties when a risk increases”, “display an action plan proposal from the generative AI on the dashboard”, and “distribute a weekly progress report to all members by email” are possible. Specifically, the notification management unit implements an event-driven messaging queue system, and asynchronously receives a notification event from each module. The notification management unit analyzes the received event data, and determines an optimal distribution channel based on a notification setting profile of a user. The notification management unit inputs the event data to a format conversion module for each platform. Specific examples of the input data include an alert object indicating that a risk level is the highest, text data of a generated weekly report, and a JSON payload including a URL link of an action plan. The format conversion module generates a message payload dedicated to each channel based on the input data. Specific examples of the output data include a markdown format text for a chat tool, a push notification payload for a smartphone, and HTML format data for email distribution. The notification management unit transmits the output result via each external API or an SMTP server. The notification management unit automatically executes a retry process using an exponential backoff algorithm when a transmission error occurs. The notification management unit ensures that important information reliably reaches related parties, and completely eliminates communication omissions and delays. The notification management unit dynamically switches the notification means according to the importance and urgency of information, thereby appropriately calling the user's attention and minimizing business interruption caused by unnecessary notifications.

A security management unit implements access control, authentication and authorization, data encryption, log audit, unauthorized access detection, data backup, disaster countermeasures, and the like on the server side, and implements terminal authentication, session management, data encryption, remote lock, data erasure, and the like on the terminal side. For example, access authority is finely set for each project to prevent leakage of confidential information and personal information. Regarding data handled by generative AI, anonymization, masking, recording of access logs, and clear indication of purpose of use are also thoroughly implemented. Specifically, the security management unit adopts a multi-layered defense architecture. The security management unit converts an input access request into a multidimensional vector. The security management unit inputs the multidimensional vector to an autoencoder-type neural network for anomaly detection. The neural network has pre-learned a latent space representation of a normal access pattern. The neural network reconstructs the input vector. The neural network calculates a reconstruction error. The security management unit outputs the reconstruction error as an anomaly score. When the anomaly score exceeds a predetermined threshold, the security management unit determines the access request as an unauthorized access. The security management unit immediately blocks the request determined as the unauthorized access. The security management unit applies a named entity recognition model to text data input to the generative AI. The named entity recognition model is based on a transformer architecture. The named entity recognition model identifies a word token corresponding to personal information or confidential information. The security management unit replaces the identified word token with a random hash value or a general noun token. By this masking process, the security management unit physically prevents confidential information from being mixed into learning data of the generative AI. The security management unit calculates a cosine similarity between a feature amount vector acquired from a biometric authentication sensor on the terminal side and a registered vector on the server side. The security management unit dynamically determines the validity of a session based on the cosine similarity. By these processes, the security management unit dramatically improves detection accuracy against unknown cyber attacks and internal frauds compared to conventional static rule-based access control. The security management unit exerts an enormous technical effect in use cases requiring extremely high confidentiality, such as a system development project of a financial institution and a construction project of a medical information system.

An operation management unit has a function that allows a system administrator to centrally manage an operation status of a server and a terminal, a learning status of an AI model, a capacity of a database, an API cooperation status, a failure occurrence status, an inquiry status from a user, and the like on a dashboard. For example, when the accuracy of the AI model decreases, relearning can be automatically executed, and when a failure occurs, the administrator can be automatically notified. System version upgrades and function additions can also be centrally managed and distributed on the server side. Specifically, the operation management unit continuously collects operation metrics of the entire system as time-series tensor data. The operation management unit inputs the time-series tensor data to a recurrent neural network. The recurrent neural network includes a long short-term memory unit. The recurrent neural network has learned a fluctuation pattern of past operation metrics. The recurrent neural network outputs a probability distribution of future system load and resource depletion. When a peak value of the probability distribution exceeds a predetermined warning threshold, the operation management unit executes an automatic scaling process of resources. The operation management unit continuously monitors a degree of divergence between an inference result of the AI model and an actual project outcome. The operation management unit quantifies the degree of divergence as a loss function. When a value of the loss function exceeds an allowable range, the operation management unit fine-tunes a weight parameter of the AI model using the latest project data as teacher data. The operation management unit applies a stochastic gradient descent method in this fine-tuning process. The operation management unit prevents overlearning by dynamically attenuating a learning rate. When a failure occurs, the operation management unit inputs a system log to a natural language processing model. The natural language processing model extracts a keyword vector indicating a root cause of the failure from an error message in the log. The operation management unit searches a database for an optimal recovery procedure based on the keyword vector. The operation management unit automatically transmits the searched recovery procedure to a terminal of the administrator. By these autonomous monitoring and control mechanisms, the operation management unit minimizes manual intervention by the system administrator. The operation management unit provides a technical effect of dramatically improving system availability and reliability in maintenance work of a cloud service infrastructure operating a large-scale parallel computing cluster, and the like.

In this way, in the system according to the present embodiment, the respective units cooperate to centrally and automatically realize collection, analysis, optimization, reporting, proposal, abnormality response, operation management, security measures, and scalability securing of all information regarding project management, thereby making it possible to significantly reduce the burden on a project manager, a team leader, and each member, and dramatically improve the success probability of a project. Specifically, the system constructs a multi-agent architecture integrating a plurality of independent neural network modules. The system asynchronously exchanges a high-dimensional feature amount vector among the respective modules. The system integrates inference results of the respective modules via a shared memory space. The system inputs the integrated inference result to a meta-learning model. The meta-learning model outputs the success probability of the entire project as a scalar value. The system dynamically optimizes a hyperparameter of each module using a reinforcement learning algorithm so as to maximize the scalar value. The system defines a progress rate and a resource consumption amount of the project as a state space. The system defines task reallocation and budget reallocation as an action space. The system defines an improvement degree of a delivery compliance rate and a quality score as a reward function. The system searches for an optimal action policy using a Q-learning algorithm. By this reinforcement learning process, the system fundamentally overturns a conventional project management method that has relied on human intuition and rules of thumb. The system redefines project management as a pure mathematical optimization problem in a high-dimensional data space. By this unconventional approach, the system optimizes complexly intertwined project variables in real time. The system exerts a technical effect of mathematically minimizing a delay risk of a project in a use case with extremely high uncertainty, such as a large-scale software development project and an international infrastructure construction project.

### Implementation Steps

### Step 1: Collection of Task Progress Data

The server cooperates with a plurality of internal and external systems such as a project management tool, a task management system, a version management system, a man-hour management system, a communication tool, a mail system, and a calendar system through an API, a Webhook, batch processing, and the like, and collects progress status data of each task in real time or periodically on the server side. For example, diverse data is collected, such as a start date and time of a task, a scheduled completion date, an actual completion date, a person in charge, a progress rate, work contents, contents of a comment column, an attached file, related minutes, a failure report, a risk report, an approval history, a change history, a dependency relationship with another related task, priority, urgency, a task type, a scale and difficulty of the task, a man-hour estimate, a frequency of a progress report, contents of the progress report, a delay status of the progress report, and a tone and an emotion analysis result of a comment of the person in charge. Specifically, the server asynchronously stores raw data in various formats transmitted from a heterogeneous environment in an integrated data lake. The server executes a data cleansing process on the stored raw data. The server performs interpolation of missing values and removal of outliers. The server applies morphological analysis and tokenization processing to text data. The server applies normalization processing to numerical data. The server converts the data that has undergone these preprocessings into a multidimensional input tensor. The server expresses numerical data such as the progress rate of the task and the man-hour estimate as a one-dimensional vector, for example. The server converts text data such as the contents of the comment column and the minutes into a dense vector using a word embedding method. The server combines these vectors of different modalities. The server supplies the combined vector to an input layer of a multimodal neural network. By this data collection and conversion process, the server constructs a data structure from which a subsequent AI model can efficiently extract features. The server eliminates data fragmentation among conventional siloed systems. The server reduces a data collection delay to a millisecond unit. The server brings about a technical effect of accurately mapping a current state of a project to a digital space without delay in a use case such as a large-scale agile development project jointly progressed by globally distributed development teams.

### Step 2: Analysis of Progress Status and Anomaly Detection (Using Generative AI)

The collected task progress data and comment contents are read into generative AI, and analyzed using technologies such as natural language processing, emotion analysis, anomaly detection, point extraction, topic classification, keyword extraction, and time-series analysis to extract a progress delay and a risk factor. Specific examples of a prompt sentence to be read into the generative AI include “Analyze the following task progress data and comment contents, and extract a progress delay and a risk factor. Since a task ID, a progress rate, a comment, a name of a person in charge, and a scheduled completion date are input, point out any sign of delay or failure, and list tasks requiring attention.” For example, when a progress report has not been submitted for a certain period of time, or when keywords such as “delay”, “failure”, and “resource shortage” frequently appear in the comment column, the generative AI detects this and automatically determines the state of the task as “requiring attention” or “at risk”. Specifically, the server inputs the preprocessed multidimensional tensor to a large language model. The large language model adopts a transformer architecture equipped with a self-attention mechanism. The server inputs, as input data, a combination of structured data and unstructured data in a prompt format, for example, indicating that the task ID is 101, the progress rate is 45 percent, the comment is waiting for confirmation due to discovery of specification inconsistency, the person in charge is engineer A, and the scheduled completion date is 3 days later. The large language model calculates a contextual dependency of the input token sequence. The large language model outputs a continuous value score from 0 to 1 indicating a delay probability of each task. The large language model simultaneously outputs a text label indicating a root cause of the risk. When the output delay probability score exceeds a threshold of 0.75, the server flags the task as a bottleneck candidate on a critical path. The server immediately transfers information of the flagged task to a subsequent resource reallocation module. By this process, the server completely eliminates a conventional process in which a human visually checks a report. The server detects a potential project risk that cannot be found by a superficial keyword search at an early stage by calculating a feature vector in a high-dimensional space. The server exerts an extremely important technical effect of preventing fatal rework in a use case such as a design and development project of a hardware product in which thousands of tasks complexly depend on each other.

### Step 3: Optimization of Personnel Allocation and Task Allocation (Using Generative AI)

Information such as a skill set, possessed qualifications, years of experience, field of expertise, past assigned task, evaluation history, self-reported skill, external training history, language ability, leadership, communication ability, stress tolerance, available overtime hours, working style, remote availability, health condition, vacation schedule, desired work, past withdrawal rate, and past failure response performance of each team member is acquired from a database, and multivariate analysis and pattern recognition are performed using generative AI to automatically generate an optimal personnel allocation plan. Specific examples of a prompt sentence to be read into the generative AI include “Based on the following member information and task information, comprehensively consider skills, workloads, past performances, and working conditions, and propose an optimal personnel allocation plan and task allocation plan. Preferentially allocate a member with high design skills to a design task, and a member with abundant failure response experience to a test process.” For example, optimization is performed such that a new task is not allocated to a member who is simultaneously progressing a plurality of tasks, and a member with availability is prioritized. Specifically, the server normalizes attribute information of each member to generate a 256-dimensional member skill vector. The server analyzes requirement specifications of each task to similarly generate a 256-dimensional task requirement vector. The server inputs these vector groups to a graph neural network. The graph neural network constructs a bipartite graph expressing a member as a node and a degree of conformity with a task as an edge weight. The graph neural network executes a message passing algorithm. The graph neural network outputs an allocation probability matrix indicating an optimal pairing of each member and each task. The server calculates an inner product of the skill vector of member B and the requirement vector of task 202, for example, to calculate a conformity score of 0.89. The server applies a combinatorial optimization algorithm such as the Hungarian method to the output allocation probability matrix. The server generates a deterministic task allocation matrix that maximizes a total conformity score of the entire project. The server writes the generated task allocation matrix into the database, and automatically transmits a new task instruction to a terminal of each member. By this process, the server realizes purely data-driven optimal resource allocation eliminating subjectivity and prejudice of an administrator. By fusing computer science graph theory and deep learning, the server solves a complex allocation problem causing a combinatorial explosion in polynomial time. The server provides a technical effect of maximizing an operation rate of human resources to the utmost limit in a use case such as a large-scale system integration project in which hundreds of engineers fluidly participate.

### Step 4: Automatic Generation and Distribution of Progress Report (Using Generative AI)

Based on data obtained from a task progress monitoring unit and a personnel allocation optimization unit, a progress report is automatically generated periodically using generative AI, and distributed to related parties through an internal chat tool or a dedicated dashboard. Specific examples of a prompt sentence to be read into the generative AI include “Create a progress report for a project manager based on the following task progress data, person in charge information, and risk information. Summarize points in an easy-to-understand manner, including a progress rate, a workload, a problem, a risk, a resource consumption status, a delivery compliance status, the number of failure occurrences, a quality evaluation, feedback from a customer, an important change history, a future issue, and a next action item.” For example, when a particularly important problem or risk is detected in the progress report, the generative AI highlights them so that the project manager or a team leader can immediately respond. Specifically, the server inputs the integrated project state vector to a natural language generation model. The natural language generation model adopts an encoder-decoder type transformer architecture. The server inputs, as input data, a numerical data array indicating, for example, that the overall progress rate is 65 percent, the number of unresolved failures is 12, and the budget consumption rate is 70 percent. The natural language generation model encodes these numerical data into a context vector. The natural language generation model autoregressively generates a natural language text stream understandable by a human through a decoder network. The natural language generation model generates, as an output, a sentence prompting a specific action, for example, indicating that a failure occurrence rate in a test process exceeds a past average by 20 percent and immediate intervention by a quality assurance team is required. The server converts the generated text stream into a structured document in an HTML format. The server automatically applies visual highlighting processing such as red text or bold text using a CSS tag to an item whose risk score exceeds a predetermined threshold. The server filters the completed structured document according to an authority level of a target person. The server push-distributes the filtered document to each terminal via a secure communication protocol. By this process, the server reduces enormous human man-hours spent on report creation to zero. The server instantaneously completes objective and comprehensive information transmission by mechanical data conversion processing. The server exerts a technical effect of eliminating information asymmetry and dramatically improving the speed of decision-making in a use case such as a system construction project for a government agency involving a plurality of stakeholders.

### Step 5: Optimization of Resource Allocation and Risk Determination (Using Generative AI)

Generative AI analyzes resource information such as an overall project budget, remaining days, the number of personnel, an operation rate, a cost consumption status, an outsourcing cost, a capital investment, a license cost, a transportation cost, a business trip cost, an education cost, an overtime cost, a progress pace, a task consumption rate, and a resource allocation status, and automatically generates an optimal resource allocation plan, risk determination, and a proposal of additional personnel and cost reduction. Specific examples of a prompt sentence to be read into the generative AI include “Determine a risk of delivery delay or budget overrun based on the following resource information and progress data, and propose additional personnel or a cost reduction measure as necessary. Simulate a plurality of resource allocation plans and present an optimal plan.” For example, when the progress pace is slow, a plan to input additional personnel is proposed, and when budget consumption is fast, a cost reduction measure is proposed. Specifically, the server constructs collected diverse resource indicators as a multidimensional time-series tensor. The server inputs the time-series tensor as an environmental state of a deep reinforcement learning agent. The deep reinforcement learning agent includes a neural network based on an actor-critic method. The server inputs, as input data, a state vector indicating, for example, that the remaining days are 45 days, the current budget consumption rate is 85 percent, and the average operation rate of main members is 110 percent. The deep reinforcement learning agent simulates a plurality of virtual resource reallocation scenarios using a Monte Carlo tree search. The deep reinforcement learning agent calculates a predicted cost and predicted delay days at the time of project completion in each scenario. The deep reinforcement learning agent generates, as an output, a specific action plan vector of, for example, reducing the outsourcing cost by 20 percent and adding three internal test personnel with the budget. The deep reinforcement learning agent simultaneously outputs a fluctuation value of a success probability when the action plan is adopted as a percentage. The server converts the output action plan vector into a human-readable proposal text, and displays it in a dedicated area of a dashboard. When an administrator approves the proposal, the server automatically applies the action plan vector as a setting parameter of the system. By this process, the server dynamically solves a complex trade-off problem that cannot be handled by a static rule base. The server prevents a project failure by deriving an optimal solution from a high-dimensional search space at high speed. The server brings about a technical effect of maximizing return on investment of limited resources in a use case such as a product development project of a startup company with extremely strict budget constraints.

Step 6: Comparative analysis with past data and optimal operation proposal (using generative AI) From a past project database, a progress status, resource consumption, an occurred problem, a risk response history, a delivery compliance rate, a quality evaluation, customer satisfaction, the number of failure occurrences, a task allocation pattern, a resource allocation pattern, a success factor, a failure factor, an external environmental factor, a project scale, a period, a member composition, a used technology, an outsourcing status, and the like of a similar project are extracted, and the generative AI performs a comparative analysis with a current project. As a specific example of a prompt sentence to be read by the generative AI, “Compare the following current project data and past project data, extract a progress trend, a risk trend, a success factor, and a failure factor, and propose an optimal operation method for the current project.” and the like can be cited. For example, a feature of a past successful project is extracted, and a proposal to increase a success probability by applying it to the current project is made. Specifically, the server extracts a feature amount of the current project and generates a query vector. The server executes an approximate nearest neighbor search using the query vector on a vector database in which all past project data is stored. The server extracts a group of past similar projects whose cosine similarity exceeds a predetermined threshold. The server compares time-series transition data of the extracted group of similar projects and time-series transition data of the current project using a dynamic time warping method. The server calculates a divergence degree of waveforms of both. The server inputs this divergence degree data and past success/failure labels to a transformer-based prediction model. The prediction model receives, as input data, a weighted network of a causal relationship that, for example, a delay in a design phase directly led to a final delivery delay in a past similar project. The prediction model outputs, as an output, a probability distribution of a failure that may occur in the future in the current project, and a specific operation change parameter for avoiding it. The prediction model outputs a prediction score that, for example, a failure occurrence rate decreases by 15 percent by changing a frequency of code review from once a week to daily. The server generates a change plan of an operation rule based on this prediction score, and presents it to an administrator. By this processing, the server extracts tacit knowledge accumulated in an organization as an explicit mathematical model. The server introduces a self-correction mechanism that mechanically avoids a past failure pattern into project management. The server exhibits a technical effect of automatically applying past lessons and continuously improving quality of a project in a use case such as a cloud migration project for an enterprise that repeats similar system migrations.

Step 7: Information browsing and operation by user interface From a terminal such as a PC, a smartphone, or a tablet, a progress status, task allocation, resource allocation, risk information, a proposal content from the generative AI, and the like can be browsed and confirmed in real time through a dashboard screen or a chat tool. On the dashboard screen, a progress graph of the entire project, a task list, a progress status by person in charge, a resource consumption status, a risk list, a comparison graph with past data, a proposal content from the generative AI, an action item list, a notification history, a comment field, a file attachment field, and the like are displayed. A user performs operations such as task progress update, comment input, resource application, problem report, risk report, approval operation, task allocation change, schedule adjustment, meeting convocation, file upload, and chat transmission on the terminal side, and the information is immediately reflected on the server side. Specifically, the terminal continuously receives structured data in a JSON format transmitted from the server via a WebSocket which is an asynchronous communication protocol. The terminal caches the received data stream in an in-memory database on a client side. The terminal optimizes a rendering process of a screen using a virtual DOM technology. The terminal detects an operation event such as a user's scroll or click. The terminal requests only necessary data from the server in accordance with the operation event. For example, when the user operates a slider of a progress rate, the terminal immediately captures the changed value as numerical data. The terminal transmits the numerical data to the server as a RESTful API request. The server commits the received update data to a main database. The server starts a recalculation process of all related AI modules in the background triggered by an update event. The server push-distributes the recalculated latest prediction result and risk score to all connected terminals. The terminal redraws only a corresponding part of the screen in milliseconds using the received difference data. By this processing, the terminal provides an extremely responsive user experience while minimizing consumption of a network bandwidth. The terminal completely automates state synchronization between the client and the server. The terminal brings about a technical effect of preventing data inconsistency and ensuring real-time information sharing in a use case of performing project management using a mobile device from a construction site or a manufacturing line floor where a communication environment is unstable.

Step 8: Automatic distribution of notification and alert A progress report, a risk warning, a proposal content from the generative AI, and the like are automatically distributed to related parties by combining a plurality of notification means such as a group chat or an individual chat of a chat tool, a notification field of a dashboard, an email notification, a push notification, and calendar cooperation. For example, when a delivery delay occurs, a person in charge and a project manager are immediately notified, and when a risk increases, a warning notification is transmitted to all related parties. Operations such as displaying an action plan proposal from the generative AI on the dashboard and distributing a weekly progress report to all members by email are possible. Specifically, the server aggregates event triggers output from each AI module to a central message broker. The message broker adopts a publish-subscribe model. The server receives an importance score of an event, an urgency flag, and profile information of a target user as inputs. The server inputs these input data to a rule engine and a decision tree-based routing algorithm. For example, when receiving a critical failure event in which the importance score is 0.9 or more and the urgency flag is true, the server confirms current presence information of the target user. The server dynamically determines an optimal distribution channel, such as selecting a desktop push notification when the user is active on a PC, and selecting an SMS transmission to a mobile terminal when the user is offline. The server asynchronously transmits a format-converted message payload to an API endpoint of the determined channel. When a transmission error occurs, the server automatically executes a retransmission process using an exponential backoff algorithm. The server collects tracking data on whether the user has opened the notification, and records it in a database. By this processing, the server prevents oversight of an important alert due to information overload at a system level. The server provides optimization of a communication path and a reliable message arrival guarantee mechanism. The server exhibits a technical effect of dramatically shortening an initial response time when an incident occurs in a use case such as a mission-critical infrastructure operation project requiring 24/7 monitoring.

Step 9: Security and operation management Access control, authentication and authorization, data encryption, log audit, unauthorized access detection, data backup, disaster countermeasure, and the like are implemented on the server side, and terminal authentication, session management, data encryption, remote lock, data erasure, and the like are implemented on the terminal side. A system administrator can centrally manage an operation status of the server and the terminal, a learning status of an AI model, a capacity of a database, an API cooperation status, a failure occurrence status, an inquiry status from a user, and the like on a dashboard. When accuracy of the AI model decreases, relearning is automatically executed, and when a failure occurs, the administrator is automatically notified. Version upgrade and function addition of the system can also be centrally managed and distributed on the server side. Specifically, the server applies a transport layer security protocol in all communication paths and encrypts packets. The server executes block-level encryption using an advanced encryption standard algorithm on data at rest stored in the database. The server executes a multi-factor authentication process combining a password hash and a one-time password in response to a user's authentication request. The server issues a JSON web token with an expiration date to a successfully authenticated user. The terminal adds the token to a header of a subsequent API request. The server realizes stateless access control by verifying a signature of the token. The server records all activities in the system as a structured log in an append-only database. The server inputs the log data to a stream processing engine in real time. The stream processing engine executes an anomaly detection model using an isolation forest algorithm. The anomaly detection model detects a behavior deviating from a normal access pattern, and outputs an anomaly score. When the anomaly score exceeds a threshold, the server automatically blocks communication from a corresponding IP address at a firewall level. The server periodically updates a holdout dataset for evaluating inference accuracy of the AI model. When an inference error exceeds an allowable range, the server automatically starts a relearning pipeline of the model using the latest dataset. By this comprehensive security and operation management architecture, the server mathematically and cryptographically ensures confidentiality, integrity, and availability of the system. The server provides a technical effect of completely protecting project data from a cyber threat in a project environment requiring extremely strict compliance requirements, such as a defense industry or a financial institution.

### Specific Use Case

For example, when applying the project management system of the present invention to an information system development project, first, all task information of the project is aggregated on the server side from a task management system, a man-hour management system, a version management system, a communication tool, and the like by API cooperation. Each task includes a task ID, a task name, a person in charge, a start date, a scheduled completion date, a progress rate, a priority, a dependency relationship, a comment, a failure report, a risk report, an approval history, a change history, a man-hour estimate, a task type, difficulty, urgency, a related file, and the like. The task progress monitoring unit collects these data in real time, gives the generative AI a prompt sentence “Analyze the following task progress data and comment contents, and extract a progress delay and a risk factor. Since a task ID, a progress rate, a comment, a name of a person in charge, and a scheduled completion date are input, point out if there is a sign of a delay or a failure, and list tasks requiring attention.”, and automatically extracts a sign of a progress delay or a failure occurrence. For example, a task for which a progress report has not been submitted for a certain period, or a task in which keywords such as “delay”, “failure”, “specification unknown”, and “resource shortage” frequently appear in a comment field is determined as “requiring attention”, and an administrator is notified. Specifically, the task progress monitoring unit normalizes the aggregated wide variety of task attribute data, and maps each task as a vector on a multidimensional feature space. The task progress monitoring unit converts a comment and a failure report, which are text data, into a dense embedding vector using a pre-trained language model. The task progress monitoring unit scales and combines a progress rate and a man-hour estimate, which are numerical data, to generate an integrated task vector. The task progress monitoring unit inputs the integrated task vector to a deep neural network. The deep neural network has a plurality of hidden layers, and has learned patterns of delays and failures from past project data. The deep neural network receives, as input data, a vector including, for example, a task ID of 305, a progress rate of 20 percent, and a text indicating that work is stopped due to unclear specifications in a comment. The deep neural network outputs, as an output, a probability that the task will cause a critical delay within the next 5 days as a score of 0.85. The deep neural network simultaneously outputs a classification label indicating that the cause is a defect in specification definition. When the output probability score exceeds a predetermined threshold of 0.7, the task progress monitoring unit automatically changes a status flag of the task to requiring attention. The task progress monitoring unit transmits an immediate alert to a terminal of a related project manager triggered by this flag change event. By this processing, the task progress monitoring unit completely eliminates an inefficient mental process in which a human reads and understands a huge amount of text and numerical values. The task progress monitoring unit discovers a minute sign of a risk overlooked by a superficial keyword search at an early stage by a vector operation in a high-dimensional space. The task progress monitoring unit exhibits a technical effect of proactively resolving a bottleneck that hinders progress of the entire project in a use case such as a large-scale cloud-native application development project in which hundreds of microservices are developed in parallel.

Next, the personnel allocation optimization unit acquires a skill set (design, implementation, test, review, project management, infrastructure construction, security, UI/UX design, document creation, customer response, etc.), years of experience, a past assigned task, an evaluation history, an operation status, a vacation schedule, a health condition, desired work, a past failure response performance, and the like of each member from a database, and gives the generative AI a prompt sentence “Based on the following member information and task information, comprehensively consider skills, workloads, past performances, and working conditions, and propose an optimal personnel allocation plan and task allocation plan. Preferentially allocate a member with high design skills to a design task, and a member with abundant failure response experience to a test process.” For example, when a design task is delayed, a member with high design skills and a low current workload is automatically allocated, and at the same time, new allocation to a member with many ongoing tasks is suppressed. Furthermore, a member with abundant failure response experience in the past is preferentially allocated to a test process in which failures frequently occur. Specifically, the personnel allocation optimization unit digitizes the acquired multifaceted attribute information of the members, and constructs a high-dimensional profile tensor representing each member. The personnel allocation optimization unit similarly digitizes required skills and difficulty of each task, and constructs a task requirement tensor. The personnel allocation optimization unit inputs these tensor data to a deep learning model equipped with an attention mechanism. The deep learning model has learned a complex non-linear relationship between member skills and task requirements. The deep learning model receives, as input data, a profile tensor indicating that, for example, a design skill score of a member C is 90, a current operation rate is 40 percent, and the number of past failure responses is 15, and a requirement tensor of a delayed design task. The deep learning model outputs a fitness score matrix for each pair of a member and a task. The deep learning model outputs, for example, a fitness score between the member C and the design task as 0.95. The personnel allocation optimization unit starts a linear programming solver with the output fitness score matrix as an input. The linear programming solver calculates an optimal task allocation matrix under a constraint condition that an upper limit of an operation rate of each member is not exceeded while maximizing total fitness of the entire project. The personnel allocation optimization unit automatically updates a person-in-charge ID on the database based on the calculated task allocation matrix. By this processing, the personnel allocation optimization unit converts an assignment work that has depended on personal intuition and experience into a pure mathematical optimization problem. The personnel allocation optimization unit instantaneously derives a global optimal solution from a huge number of combinations utilizing computer resources. The personnel allocation optimization unit brings about a technical effect of preventing resource bias and maximizing productivity of the entire project in a use case such as system development in a matrix-type organization in which many engineers concurrently work on a plurality of projects.

The progress report generation unit gives the generative AI a prompt sentence “Based on the following task progress data, person-in-charge information, and risk information, create a progress report for a project manager. Include a progress rate, a workload, a problem, a risk, a resource consumption status, a delivery compliance status, the number of failure occurrences, a quality evaluation, feedback from a customer, an important change history, a future issue, and a next action item, and summarize points in an easy-to-understand manner.” based on data obtained from the task progress monitoring unit and the personnel allocation optimization unit, and automatically generates a progress report on a daily or weekly basis. For example, points such as “A design task is assigned to Mr. A, and progress is 80%, but a delay is expected due to an influence of a specification change, so input of additional personnel is recommended” and “A test process is assigned to Mr. B, and the number of failures is on an increasing trend, so strengthening of quality control is necessary” are described in the progress report. These reports are automatically distributed to related parties through a chat tool or a dashboard. Specifically, the progress report generation unit integrates structured data collected from each module in the system into a data tree in a JSON format. The progress report generation unit formats the data tree as an input prompt of a large language model specialized for natural language generation. The large language model is composed of a transformer network having hundreds of billions of parameters. The progress report generation unit inputs, as input data, quantitative data indicating that, for example, an overall progress rate is 75 percent, the number of unresolved bugs is 23, and a budget overrun risk is 15 percent, and an array of status flags of each task. The large language model analyzes a hierarchical structure of the input data tree, and extracts an important index. The large language model autoregressively generates a text paragraph having a context that can be naturally read by a human based on the extracted index. The large language model outputs, as an output, a specific warning sentence that, for example, a current bug convergence curve is significantly below a schedule, and a probability of not satisfying a release criterion reaches 80 percent, and a text of an action plan to add two test personnel. The progress report generation unit converts the generated text into a document in a markdown format. The progress report generation unit transmits the document to an API endpoint of an internal communication platform as an HTTP POST request. By this processing, the progress report generation unit completely unmanned a series of processes from data aggregation to report creation and distribution. The progress report generation unit realizes objective and accurate visualization of a project state from which subjectivity is excluded by mechanical data processing. The progress report generation unit exhibits a technical effect of reducing an overhead of reporting work and supporting rapid decision-making in a use case such as a large-scale digital transformation promotion project in which regular reporting to a management layer and a plurality of stakeholders is obliged.

The resource management optimization unit causes the generative AI to analyze an overall project budget, remaining days, the number of personnel, an operation rate, a cost consumption status, an outsourcing cost, a capital investment, a license cost, a transportation cost, a business trip cost, an education cost, an overtime cost, a progress pace, a task consumption rate, a resource allocation status, and the like with a prompt sentence “Based on the following resource information and progress data, determine a risk of a delivery delay or a budget overrun, and propose additional personnel or a cost reduction measure as necessary. Simulate a plurality of resource allocation plans, and present an optimal plan.” For example, when a progress pace is slow, a proposal such as “A delivery delay risk can be reduced by allocating two additional personnel to a test process” is automatically generated, and when budget consumption is fast, a proposal such as “Review outsourcing of a design process to achieve cost reduction” is automatically generated. Specifically, the resource management optimization unit normalizes a wide variety of financial and progress metrics, and generates a multidimensional state vector indicating a current state of the project. The resource management optimization unit inputs the multidimensional state vector to a deep Q-network. The deep Q-network has learned an optimal resource allocation policy from past project data using a reinforcement learning algorithm. The resource management optimization unit inputs, as input data, a numerical array indicating that, for example, a remaining budget is 3 million yen, remaining days are 20 days, and a current task consumption speed is 5 tasks per day. The deep Q-network evaluates a plurality of resource reallocation actions from a possible action space. The deep Q-network outputs a Q-value which is an expected reward value for each action. The deep Q-network outputs, for example, a Q-value of 0.85 for an action of canceling outsourcing and switching to an internal resource, and outputs a Q-value of 0.42 for an action of procuring test personnel from the outside. The resource management optimization unit selects an action having the maximum Q-value as an optimal solution. The resource management optimization unit outputs the selected action to the system as a specific parameter change instruction. The resource management optimization unit simultaneously presents a predicted completion date and a predicted final cost when the action is executed as a simulation result. By this processing, the resource management optimization unit realizes dynamic and non-linear resource optimization, which is impossible by conventional manual calculation using a static spreadsheet. The resource management optimization unit mathematically specifies a path with the highest expected value in a high-dimensional search space. The resource management optimization unit provides a technical effect of maximizing a profit margin of a project and minimizing a deficit risk in a use case such as an agile software development project in which constraints on a budget and a delivery date are extremely strict and a situation changes momentarily.

The past data comparative analysis unit extracts a progress status, resource consumption, an occurred problem, a risk response history, a delivery compliance rate, a quality evaluation, customer satisfaction, the number of failure occurrences, a task allocation pattern, a resource allocation pattern, a success factor, a failure factor, an external environmental factor, a project scale, a period, a member composition, a used technology, an outsourcing status, and the like of a similar project from a past project database, and gives the generative AI a prompt sentence “Compare the following current project data and past project data, extract a progress trend, a risk trend, a success factor, and a failure factor, and propose an optimal operation method for the current project.” For example, a feature of a past successful project is extracted, and an optimal operation proposal such as “Strengthen progress management of a design process and execute a progress review weekly” or “Execute a new employee education program early” is made to the current project. Specifically, the past data comparative analysis unit combines various attribute data of the current project to generate a feature vector. The past data comparative analysis unit executes a K-nearest neighbor algorithm on a group of past projects stored in a vector database using the feature vector. The past data comparative analysis unit extracts top K similar project data having the closest Euclidean distance. The past data comparative analysis unit compares time-series transition data of the extracted similar project and time-series transition data of the current project using a dynamic time warping method. The past data comparative analysis unit calculates a divergence degree of waveforms of both. The past data comparative analysis unit inputs this divergence degree data and past success/failure labels to a transformer-based prediction model. The prediction model inputs, as input data, history data indicating that, for example, when the number of customer reviews in a requirement definition phase was less than 3 in a past similar project, a rework rate in a subsequent process increased by 50 percent, in a tensor format. The sequence conversion model predicts a future event sequence from a current state of the current project. The sequence conversion model outputs, as an output, a probability that rework will occur in the current project as a score of 0.72, and outputs a specific operation rule change plan for avoiding it in a text format. The past data comparative analysis unit displays the output operation rule change plan on a management dashboard as a recommended setting of the system. By this processing, the past data comparative analysis unit activates a huge amount of past data buried in an organization, and constructs a data-driven decision-making support mechanism. The past data comparative analysis unit executes comprehensive pattern recognition exceeding limits of human memory and empirical rules. The past data comparative analysis unit exhibits a technical effect of statistically and dramatically improving a success probability of a project in a use case such as a large-scale core system renewal project in which the same mistake is likely to be repeated despite experiencing a similar failure in the past.

The user interface unit allows viewing and confirming a progress status, task allocation, resource allocation, risk information, a proposal content from generative AI, and the like in real time from a terminal such as a PC, a smartphone, or a tablet through a dashboard screen or a chat tool. On the dashboard screen, a progress graph of the entire project, a task list, a progress status by person in charge, a resource consumption status, a risk list, a comparison graph with past data, a proposal content from the generative AI, an action item list, a notification history, a comment field, a file attachment field, and the like are displayed. A user performs operations such as task progress update, comment input, resource application, problem report, risk report, approval operation, task allocation change, schedule adjustment, meeting convocation, file upload, and chat transmission on the terminal side, and the information is immediately reflected on the server side. Specifically, the user interface unit adopts a single-page application architecture and operates on a client terminal. The user interface unit issues a query to a GraphQL endpoint on the server side, and pinpoints and acquires only data necessary for screen rendering. The user interface unit stores the acquired JSON data in a state management library on the client side. When detecting a change in state data, the user interface unit executes a difference algorithm of a virtual DOM, and redraws only a necessary node of an actual DOM tree. When the user operates a slider for updating a progress rate of a task, the user interface unit captures the operation event, and transmits a mutation request including a numerical value of a new progress rate in a payload to the server. After updating a database, the server broadcasts the changed data to all connected clients through subscription communication. The user interface unit synchronizes the progress graph and the task list on the screen in milliseconds using the received broadcast data. By this processing, the user interface unit completely eliminates inefficient communication overhead of a conventional web application accompanied by reloading of the entire page. The user interface unit provides smooth operability equivalent to that of a native application while saving a network bandwidth. The user interface unit brings about a technical effect of preventing information delay and conflict and maximizing collaboration efficiency of the entire team in a use case such as a daily scrum of agile development in which a large number of members simultaneously access the system and frequently update data.

The notification management unit automatically distributes a progress report, a risk warning, a proposal content from the generative AI, and the like to related parties by combining a plurality of notification means such as a group chat and an individual chat of a chat tool, a notification field of a dashboard, an email notification, a push notification, and calendar cooperation. For example, when a progress delay occurs, the person in charge and a project manager are immediately notified, and when a risk increases, a warning notification is transmitted to all related parties. Operations such as displaying an action plan proposal from the generative AI on the dashboard and distributing a weekly progress report to all members by email are possible. Specifically, the notification management unit enqueues all events occurring in the system into a message queue as an event stream. The notification management unit dequeues the event from the queue and inputs the event to an event routing engine. The event routing engine refers to a notification setting profile and current context information of each user. The notification management unit receives, as input data, context data indicating, for example, a progress delay event of task ID 404, a high importance level, and that a current login state of a target user is a mobile terminal. The notification management unit executes an algorithm for dynamically determining an optimal distribution channel based on these data. For example, when the target user is using a mobile terminal, the notification management unit generates an API request to a standard push notification service provided by a mobile OS, and immediately transmits the API request. When the target user is offline, the notification management unit transmits a message via an SMTP server of an email. The notification management unit tracks a distribution status of the transmitted notification, and automatically executes fallback processing to another channel when an error occurs. By this processing, the notification management unit eliminates communication uncertainty that important information does not reach the user at a system level. The notification management unit establishes an optimal information transmission path according to the user's situation. The notification management unit exhibits a technical effect of minimizing a time lag from detection of an incident to recognition by a person in charge and supporting rapid recovery work in a use case such as a system maintenance and operation project requiring an emergency response when a failure occurs.

As described above, the project management system of the present invention can centrally and automatically realize project progress management, personnel allocation, resource allocation, risk management, past data analysis, progress report, notification distribution, and the like by multilayered data analysis and optimization processing utilizing generative AI, significantly reduce burdens on a project manager, a team leader, and each member, and dramatically improve a success probability of a project. Specifically, the system functions as an autonomous project control platform integrating a plurality of specialized neural networks and a reinforcement learning agent. The system takes in high-dimensional stream data constantly generated from a project environment in real time, and continuously updates an internal latent space representation. The system forms a closed-loop control system in which each AI module asynchronously executes inference and mutually feeds back the result via a shared memory space. The system constantly receives, as input data, a huge tensor array indicating states of all tasks, all members, and all resources of the project. The system dynamically and continuously generates, as output, an optimal task allocation matrix, a resource allocation vector, and an operation rule change parameter for maximizing the success probability of the project. By this advanced computer science approach, the system mathematically unravels entanglement of complex variables exceeding human cognitive limits. The system fundamentally evolves a conventional management method based on a static tool or an empirical rule into a data-driven and self-adaptive intelligent control system. The system provides an enormous technical effect of reducing a fatal risk of project delay or budget overrun to the utmost limit by the power of an algorithm and strongly guaranteeing completion of the project in all use cases such as modern software development and large-scale infrastructure construction where uncertainty is high and requirement changes frequently occur.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment For Carrying Out the Present Invention

An embodiment for carrying out the present invention will be described in detail with further specificity. The factory robot management system of the present invention is composed of a server and a terminal, executes multilayered data analysis and optimization processing with generative AI as a core on the server side, and allows a site worker or a manager to perform operation, viewing, input, and confirmation on the terminal side. Hereinafter, each component will be described with extreme depth, including a large number of specific examples. Specifically, the system adopts a distributed computing architecture. The system arranges a parallel computing cluster composed of a plurality of computing nodes on the server side. The server implements a large language model and a neural network for time series prediction. The system acquires streaming data at high frequency from various sensor groups in a factory. The system converts the acquired data into a multidimensional tensor. The system expands the converted tensor on a memory. The system asynchronously returns an analysis result in response to a request from the terminal side. Thereby, the system minimizes a communication delay. The system eliminates conventional visual confirmation by a human. The system calculates optimization of the entire factory by vector operation in a high-dimensional space. Thereby, the system dramatically improves an operation rate of a production line. The system is applied to a large-scale production base such as an automobile manufacturing factory or a semiconductor manufacturing factory.

First, the robot operation status monitoring unit collects information such as operation states, skills, workloads, maintenance histories, failure occurrence statuses, and work progresses of a plurality of robots and workers arranged in the factory in real time. For example, “operating”, “standing by”, “stopped”, “under maintenance”, “abnormally stopped”, and the like are acquired as the operation state of the robot, and “number of currently assigned tasks”, “operation rate in the latest one hour”, “cumulative operation time”, “continuous operation time”, “latest pause time”, “operation/stop history in the past 24 hours”, and the like are recorded as the workload. As the maintenance history, “last maintenance implementation date”, “past maintenance content”, “abnormality detection history during maintenance”, “type and replacement timing of replacement part”, “maintenance worker”, “maintenance work time”, “operation status after maintenance”, and the like are managed. As the failure occurrence status, “latest failure occurrence date and time”, “failure content (e.g., sensor abnormality, motor abnormality, communication disconnection, temperature abnormality, power supply abnormality, etc.)”, “failure response history”, “operation condition at the time of failure occurrence”, “assigned task at the time of failure occurrence”, “parts supply status at the time of failure occurrence”, and the like are recorded. As the work progress, “progress rate of each task”, “start date and time/scheduled end date and time of task”, “delay status”, “dependency relationship of task”, “task priority”, “difficulty of the task”, “person in charge/robot in charge of task”, “man-hour estimate of task”, “actual man-hour of task”, “quality evaluation of task”, and the like are acquired. These pieces of information are aggregated into the server from various sensors (position sensor, temperature sensor, vibration sensor, current sensor, pressure sensor, image sensor, etc.), a robot control system, an MES, a SCADA, a site terminal, and an input device of a worker (tablet, smartphone, wearable terminal, voice input terminal, etc.) through an API, an IoT gateway, wireless communication, batch cooperation, file transfer, and the like. The generative AI analyzes these diverse data using technologies such as natural language processing, abnormality detection, time series analysis, clustering, pattern recognition, causal inference, outlier detection, state estimation, and emotion analysis, and automatically detects a sign of abnormality and an operation abnormality such as, for example, “detecting a robot whose operation rate is rapidly decreasing”, “extracting a tendency that failures frequently occur in a task assigned to a specific worker”, “identifying a robot whose maintenance interval exceeds a specified value”, “automatically extracting a task in which a progress delay occurs”, “recommending a pause to a robot whose continuous operation time is too long”, “extracting a common factor of robots in which abnormal stops frequently occur”, and “detecting a sign of stress or fatigue from an input comment of a worker”. Specifically, the robot operation status monitoring unit normalizes the collected various data. The monitoring unit stores the normalized data in a memory as a time series array. The monitoring unit inputs the time series array to a multilayer perceptron and a long short-term memory network. The monitoring unit uses, as input data, for example, a 128-dimensional sensor data vector, a 64-dimensional operation history vector, and an embedding vector of a maintenance record described in natural language. The monitoring unit executes linear interpolation of a missing value and smoothing of an outlier as preprocessing. The monitoring unit combines these vectors to generate a 256-dimensional input tensor. The monitoring unit inputs the input tensor to a large language model and an abnormality detection model. The abnormality detection model adopts an autoencoder architecture. The abnormality detection model compresses the input tensor into a low-dimensional latent space. The abnormality detection model reconstructs the original tensor from the latent space. The abnormality detection model calculates a reconstruction error. The abnormality detection model determines an abnormality when the reconstruction error exceeds a predetermined threshold. The monitoring unit generates, as output data, a score value from zero to one indicating an abnormality occurrence probability of each robot, a feature importance vector indicating a factor of the abnormality, and a warning text in natural language. For example, the monitoring unit outputs a text indicating that a probability that motor vibration of robot A exceeds a threshold is 85 percent. For example, the monitoring unit outputs a text indicating that a fatigue degree of worker B exceeds a specified value. The monitoring unit transmits the output result to the subsequent work allocation optimization unit. The monitoring unit issues an emergency stop command for the robot to the control system based on the output result. Thereby, the monitoring unit prevents a serious mechanical failure. The monitoring unit completely substitutes for monitoring work by human visual inspection. The monitoring unit dramatically improves accuracy of abnormality detection by real-time processing of high-dimensional data. The monitoring unit is applied to a use case such as a precision machining line or a food packaging line.

The work allocation optimization unit comprehensively analyzes the data acquired by the robot operation status monitoring unit and a skill (welding, assembly, inspection, conveyance, painting, palletizing, picking, screw tightening, soldering, parts supply, quality inspection, image recognition, etc.), a workload, an operation state, a maintenance history, a parts supply status, a task priority, a process progress, a site layout of each robot, and a skill, a workload, a health condition, and a vacation schedule of a worker by the generative AI, and automatically determines optimal work allocation and operation scheduling. For example, optimization is performed by compositely considering skills, workloads, maintenance, operation states, task priorities, parts supply statuses, site layouts, and worker situations, such as preferentially allocating a robot having a welding skill, currently operating, and having a low workload to a welding task, avoiding allocation of a robot having an assembly skill but requiring maintenance recently, preferentially allocating an inspection task to a worker having abundant failure response experience, allocating a conveyance task to a robot having a conveyance skill and being closest on the site layout, allocating a picking task to a robot having high AI image recognition accuracy, preferentially allocating a robot having a high operation rate at night or on a holiday, and automatically generating a reasonable shift in consideration of the health condition and vacation schedule of the worker. Furthermore, recalculation of allocation and reallocation are executed in real time according to a progress of an ongoing task and a change in a site situation (parts supply delay, sudden failure of a robot, sudden poor physical condition of a worker, site layout change, occurrence of a bottleneck between processes, etc.), and flexible scheduling is realized, such as, for example, temporarily stopping a task of a corresponding process and reallocating resources to another process when a parts supply delay occurs, automatically changing allocation to another robot or worker immediately when a sudden failure of a robot occurs, recommending a break and reallocating a task to another worker or robot when poor physical condition of a worker is detected, recalculating a shortest flow line and optimizing a conveyance task when a site layout is changed, and dynamically adjusting resource allocation between processes when a bottleneck between processes occurs. Specifically, the work allocation optimization unit uses a neural network implementing a reinforcement learning algorithm. The optimization unit constructs a state space model based on a Markov decision process. The optimization unit acquires, as input data, a two-dimensional coordinate vector indicating a current position of each robot, a one-hot encoding vector indicating a required skill of each task, and a continuous value tensor indicating a fatigue degree of a worker. The optimization unit normalizes these data as preprocessing to generate a 512-dimensional state vector. The optimization unit inputs the state vector to a transformer-based encoder. The optimization unit calculates a degree of association between each robot and each task using a self-attention mechanism. The optimization unit generates, as output data, a probability distribution matrix of task allocation to each robot. For example, the optimization unit outputs, as output data, a score indicating that a probability of allocating task number 105 to robot C is 92 percent. For example, the optimization unit outputs, as output data, a score indicating that a probability of transitioning worker D to a break state is 88 percent. The optimization unit selects an action sequence having the highest expected reward based on the probability distribution matrix. The optimization unit converts the selected action sequence into a control command group. The optimization unit transmits the control command group to a control unit of each robot. The optimization unit sets minimization of a task completion time of the entire factory and minimization of a moving distance of the robot as a reward function. The optimization unit sequentially updates weights of the neural network using a proximal policy optimization algorithm. Thereby, the optimization unit improves an adaptive capability to a dynamic environmental change. The optimization unit eliminates a conventional scheduling method depending on human intuition. The optimization unit maximizes production efficiency by optimization calculation in a high-dimensional space. The optimization unit is applied to a use case such as an assembly factory performing high-mix low-volume production or a large-scale logistics warehouse.

The maintenance management optimization unit analyzes an operation time, the number of days elapsed since the last maintenance, a failure occurrence history, an operation pattern, a replacement part history, a skill of a maintenance worker, a maintenance work time, an operation status after maintenance, a maintenance cost, a maintenance part inventory, and the like of each robot by the generative AI, and performs automatic proposal of maintenance timing, recommendation of preventive maintenance, and immediate alert transmission at the time of a sign of abnormality. For example, a notification of “maintenance recommended” is given to a robot whose operation time exceeds a specified value, and an alert of “emergency maintenance recommended” is issued to a robot in which failures frequently occur recently. A maintenance history and a failure occurrence pattern are learned, tendencies such as, for example, “a failure occurrence rate decreased after replacement of a specific part”, “failures frequently occur under a specific work condition”, and “operation stability after maintenance differs depending on a skill of a maintenance worker” are extracted, and optimal maintenance content and timing, worker allocation, and advance preparation of a maintenance part are proposed. Furthermore, a progress and a result of maintenance work are also recorded and reflected in a maintenance plan from the next time onward. For example, when an inventory of a maintenance part is insufficient, an automatic ordering instruction of “replenishment of maintenance part recommended” is issued. Specifically, the maintenance management optimization unit adopts a hybrid architecture combining a survival analysis model and a graph neural network. The optimization unit acquires, as input data, a numerical vector indicating a cumulative operation time for each part of each robot, an embedding vector obtained by performing natural language processing on a past failure occurrence log, and an adjacency matrix indicating a physical connection relationship between parts. The optimization unit tokenizes text data as preprocessing and converts the text data into a 768-dimensional vector using a pre-trained language model. The optimization unit inputs these input data to a graph convolutional network. The optimization unit updates a feature amount of each node. The optimization unit outputs, as output data, a prediction score indicating a failure probability of each part within the next 30 days, structured text data indicating a recommended maintenance work procedure, and a list of necessary replacement parts. For example, the optimization unit outputs a prediction score indicating that a probability that a servomotor of robot E fails within two weeks is 78 percent. For example, the optimization unit outputs structured data indicating that maintenance worker F is allocated and part G is replaced. The optimization unit transmits the output result to the parts supply monitoring unit and the notification management unit. The optimization unit automatically generates a maintenance schedule when the prediction score exceeds a predetermined threshold. The optimization unit performs learning of the model using a cross-entropy error function. The optimization unit optimizes weights of the network by a gradient descent method. Thereby, the optimization unit realizes a complete transition from breakdown maintenance to predictive maintenance. The optimization unit eliminates a maintenance plan based on a human empirical rule. The optimization unit dramatically reduces downtime by objective probability calculation by machine learning. The optimization unit is applied to a use case such as maintenance management of a chemical plant or a semiconductor manufacturing apparatus requiring continuous operation.

The parts supply monitoring unit monitors and analyzes an inventory status, a consumption pace, a supply delay, quality data, supplier information, an ordering history, a delivery history, a lot number of a part, an expiration date, a storage location, traceability information of a part, and the like for each part by the generative AI, and performs a replenishment proposal and an automatic ordering instruction at the time of inventory shortage, alert transmission at the time of supply abnormality, a supplier change proposal, a defect tendency analysis of a part lot, and the like. For example, when an inventory of part A becomes less than 10, a notification of “replenishment of part A recommended” is given, and when supply of part B is delayed from a schedule, an alert of “supply delay of part B, process adjustment recommended” is issued. A consumption pace and a past supply history are learned, patterns such as, for example, “part C tends to increase in consumption on weekends” and “part D has a high defect rate in a specific process” are extracted, and a replenishment plan and a supplier review are automatically generated in advance. Quality data is also referred to, and proposals such as, for example, “when a defect rate is increasing in a specific lot of part E, suspension of use of the corresponding lot and a claim proposal to a supplier” and “when an expiration date of part F is near, priority consumption recommended” are made. Specifically, the parts supply monitoring unit implements an autoregressive time series prediction neural network. The monitoring unit acquires, as input data, a one-dimensional time series array indicating a daily parts consumption amount for the past one year, a categorical variable vector indicating a delivery delay record of a supplier, and an environmental variable tensor including external weather information and traffic information. The monitoring unit calculates a moving average of time series data and separates a seasonal variation component as preprocessing. The monitoring unit combines these data to generate a 256-dimensional input feature amount vector. The monitoring unit inputs the input feature amount vector to a cell of a long short-term memory network. The monitoring unit updates a hidden state vector for each time step. The monitoring unit outputs, as output data, a numerical array indicating a daily parts consumption amount prediction value for the next 14 days, a probability score from zero to one indicating an inventory depletion risk, and an integer value indicating an optimal ordering quantity. For example, the monitoring unit outputs a numerical array indicating that a consumption amount prediction value of part H after three days is 500. For example, the monitoring unit outputs a probability score indicating that an inventory depletion risk of part I is 95 percent. The monitoring unit transmits the output result to an external automatic ordering system via an API. The monitoring unit automatically generates an ordering transaction when the probability score exceeds a threshold. The monitoring unit learns the model by backpropagation using a mean square error as a loss function. Thereby, the monitoring unit simultaneously achieves reduction of excess inventory and prevention of stockout. The monitoring unit eliminates inventory management depending on human intuition. The monitoring unit realizes optimization of the entire supply chain by correlation analysis of high-dimensional data. The monitoring unit is applied to a use case such as an electronic device assembly factory or an automobile parts warehouse handling tens of thousands of parts.

The quality analysis unit multilaterally analyzes quality data, the number of defective product occurrences, an inspection result, a past quality trouble history, a parts supply history, an assignment history of a worker or a robot, quality comparison between processes, a quality cost, feedback from a customer, a quality audit result, a quality improvement activity history, and the like associated with each process or task, identifies a process or a person in charge where defects frequently occur, and automatically proposes early detection of a quality problem, a process improvement plan, a reassignment plan for the person in charge, a review plan for a parts supply route, a reinforcement plan for an inspection process, a proposal of a quality education program, a quality cost reduction plan, and the like. For example, when defective products frequently occur in an assembly process, improvement plans such as “review of work procedure of assembly process recommended”, “re-education of person in charge proposed”, “accuracy inspection of corresponding robot recommended”, “review of parts supply route”, “supplier change”, and “introduction of additional inspection process” are issued. When defects are concentrated on a specific part in an inspection process, “traceability investigation of part lot”, “quality improvement request to supplier”, “introduction of additional inspection process”, and the like are proposed. A quality warning and an improvement proposal are immediately notified to a manager or a site supervisor through the report generation unit. Specifically, the quality analysis unit adopts a multimodal AI architecture integrating a convolutional neural network and a large language model. The analysis unit acquires, as input data, a high-resolution image tensor obtained by photographing a surface state of a product, a three-dimensional shape data vector output from an inspection apparatus, and a natural language text describing a claim content from a customer. The analysis unit resizes the image tensor to 256 pixels square and normalizes a pixel value to a range from zero to one as preprocessing. The analysis unit tokenizes text data in units of subwords. The analysis unit inputs the image tensor to a visual encoder and inputs the text data to a language encoder. The analysis unit combines output vectors from both encoders in a cross-attention layer. The analysis unit outputs, as output data, a binary classification label for determining quality of a product, a bounding box coordinate array indicating a cause location of a defect, and a generated text indicating a specific action plan for quality improvement. For example, the analysis unit outputs a classification label indicating that a probability that a minute scratch exists on a surface of product J is 99 percent. For example, the analysis unit outputs a coordinate array indicating that coating unevenness is detected in an area of coordinates X 100 and Y 200. For example, the analysis unit outputs a generated text indicating that a nozzle pressure of a painting robot should be reduced by 5 percent. The analysis unit transmits the output result to the report generation unit and the robot control system. The analysis unit generates an interlock signal for temporarily stopping operation of a corresponding line when defect determinations continue. The analysis unit optimizes a multimodal representation space using contrastive learning. Thereby, the analysis unit detects a minute defect difficult to discover by human visual inspection with high accuracy. The analysis unit completely automates a quality control process and dramatically improves a yield rate. The analysis unit is applied to a use case such as a manufacturing line of a precision electronic component or a quality inspection process of a medical device.

The report generation unit generates a detailed report including an operation status of the entire factory, work progress, a maintenance status, a parts supply status, a quality status, an abnormality detection content, an optimization proposal, an improvement history, a cost analysis, comparison between processes, feedback from a site, a future prediction by AI, and the like based on analysis results of the respective units, and automatically distributes the detailed report to a manager or a site supervisor. For example, a report summarizing “operation rate transition for each robot”, “progress status for each task”, “maintenance implementation history and future maintenance schedule”, “parts inventory transition and replenishment history”, “time series transition of quality data”, “number of abnormality detections and response history”, “list of optimization proposals by AI”, “transition of quality cost”, “quality comparison between processes”, “improvement proposal from site and its implementation status”, “future quality/operation prediction by AI”, and the like on a daily, weekly, or monthly basis is created. Furthermore, the report can be viewed in real time on a site terminal or a dashboard for a manager, and is notified by a chat tool, an email, or the like as necessary. For example, when a site worker inputs a progress on a tablet, AI analysis runs immediately, and the latest optimization proposal and abnormality warning are displayed on the manager dashboard. When a failure occurs at the site, the AI refers to a past failure history and a maintenance history, and immediately proposes an optimal response procedure and a person in charge. Specifically, the report generation unit implements a transformer-based large language model specialized for natural language generation. The generation unit acquires, as input data, a structured data group aggregated from each unit. The generation unit acquires, as input data, for example, a floating-point array indicating an operation rate of each robot, a text in JSON format including log data of abnormality detection, and an improvement proposal text vector from the quality analysis unit. The generation unit embeds these heterogeneous data into a specific prompt template as preprocessing. The generation unit inputs the prompt to the large language model. The generation unit calculates an appearance probability of a word through an autoregressive decoding process. The generation unit outputs, as output data, comprehensive report data structured in HTML format, a plain text including a summary sentence, and a data array for graph drawing for dashboard display. For example, the generation unit outputs a summary sentence indicating that overall equipment effectiveness of the entire factory today is 85 percent, which is improved by 2 points compared to the previous day. For example, the generation unit outputs an analysis text indicating that a factor of an operation rate decrease of robot K is a supply delay of part L. The generation unit transmits the output result to the notification management unit and the user interface unit. The generation unit persists the output result in a database to enable difference analysis with a past report. The generation unit completely eliminates data aggregation and report creation work by human manual work. The generation unit converts a huge amount of numerical data into an insight intuitively understandable by a human. Thereby, the generation unit dramatically improves a decision-making speed of a management layer. The generation unit is applied to a use case such as a decision-making support system for a headquarters or a factory manager of a global manufacturing company supervising a plurality of factories.

For example, at the start of operation in the morning, the states of all robots and parts inventories are automatically checked, and optimal work allocation and parts replenishment instructions are automatically issued. During operation, progress and abnormalities are monitored in real time, and when maintenance or a quality problem is predicted, an alert is immediately transmitted. At the end of work, a daily report summarizing the overall progress, quality, and operation status is automatically generated and distributed to a manager. For example, when the operation rate of a welding robot decreases, a notification “maintenance of welding robot recommended” is given, and when defective products frequently occur in an assembly process, an alert “review of work procedure in assembly process recommended” is issued. When the inventory of part A is short, an automatic ordering instruction “replenishment of part A recommended” is issued. When defects are concentrated on a specific part in an inspection process, “review of parts supply route” is proposed. When a new process is added at a site or when a skill set of a robot is updated, the AI immediately recalculates the overall work allocation and resource allocation, and automatically generates an optimal operation plan. Even when a sudden failure or trouble occurs, the AI refers to past similar cases and presents a prompt countermeasure and a risk avoidance plan. When managing across a plurality of factories, overall resource optimization, quality comparison, and best practice sharing between processes can also be automated. Specifically, the present system integrally controls a series of processes using an event-driven microservice architecture. The present system acquires, as input data, streaming data of various sensors to which a time stamp is added by a time synchronization protocol and an asynchronous event notification from an external system. The present system filters and aggregates the data using an event stream processing engine as preprocessing. The present system routes the aggregated data to each optimization module. The present system outputs, as output data, a real-time control command group for each robot, a push notification payload to a worker terminal, and a transaction query for database update. The present system outputs log data indicating that, for example, an initialization sequence of all robots is completed and a task allocation matrix is applied at 8:00 am. The present system outputs a control history indicating that, for example, abnormal vibration of a welding robot M is detected and a task handover command to an alternative robot N is issued at 2:15 pm. The present system autonomously controls the physical operation of the entire factory based on this output result. The present system continuously updates a policy from daily operation data using a reinforcement learning agent. The present system thereby realizes optimization in a dynamic environment that cannot be handled by static rule-based control. The present system enables autonomous operation of the factory without human intervention. The present system is applied to use cases such as construction of a completely unmanned line in a smart factory and dynamic optimization of a global supply chain in which a plurality of bases are linked.

As described above, in the embodiment of the present invention, by executing multilayered data analysis and optimization processing with the generative AI as a core on the server side and providing a user interface and a notification function on the terminal side, the operation status, work allocation, maintenance management, parts supply, quality management, process improvement, site feedback, and future prediction of robots and workers in the factory are optimized in real time and automatically, and improvement in productivity and quality at the site, reduction in downtime and defective rate, significant reduction in human burden, and company-wide sharing of site knowledge can be realized. Specifically, the present system constructs a distributed processing infrastructure in which an edge computing node and a cloud server are linked. The present system acquires, as input data, a low-latency control data vector primarily processed by the edge node and a petabyte-class historical operation data tensor accumulated in the cloud server. The present system performs dimensionality reduction of data on the edge side as preprocessing to save a communication band. The present system constructs a large-scale ensemble learning model on the cloud side. The present system outputs, as output data, a scalar value indicating a comprehensive optimization index of the entire factory, an update vector of a hyperparameter for each subsystem, and a natural language report indicating a strategic insight for a management layer. The present system outputs an evaluation index indicating that, for example, energy consumption of the entire factory is reduced by 15 percent by introducing the present system. The present system outputs a strategic proposal recommending that, for example, a robot arrangement layout be changed to a pattern X in launching a next production model. The present system continuously updates a digital twin model of the entire factory based on this output result. The present system feeds back a simulation result in a cyber space to a physical space. The present system thereby achieves global optimization that surpasses conventional local improvement activities by humans. The present system improves data processing efficiency of computer technology itself. The present system is applied to digital transformation of all manufacturing industries as a core platform driving next-generation Industry 4.0.

### System Configuration

The system according to the present embodiment includes a robot operation status monitoring unit, a work allocation optimization unit, a maintenance management optimization unit, a parts supply monitoring unit, a quality analysis unit, a report generation unit, a user interface unit, a notification management unit, a data integration unit, and an AI prompt management unit. The robot operation status monitoring unit collects information such as operation states, skills, workloads, maintenance histories, failure occurrence statuses, and work progresses of a plurality of robots and workers in a factory in real time, acquires states such as operating, waiting, stopped, under maintenance, and abnormally stopped from a sensor or a control system, for example, records the number of currently assigned tasks, an operation rate in the latest one hour, an accumulated operation time, a continuous operation time, an operation/stop history in the past 24 hours, and the like as the workload, manages a last maintenance implementation date, past maintenance contents, types and replacement timings of replacement parts, a maintenance worker, a maintenance work time, an operation status after maintenance, and the like as the maintenance history, records a latest failure occurrence date and time, failure contents, a failure response history, an operation condition and an assigned task at the time of failure occurrence, a parts supply status, and the like as the failure occurrence status, and acquires a progress rate of each task, a start date and time/scheduled end date and time, a delay status, a dependency relationship, a priority, a difficulty, a person in charge/robot in charge, a man-hour estimate, an actual man-hour, a quality evaluation, and the like as the work progress. A prompt sentence such as “Analyze the following robot operation data, workload, maintenance history, failure occurrence status, and work progress data, and extract a sign of abnormality and an operation abnormality. If there is a sign of a decrease in operation rate or an abnormal stop, point it out and list robots requiring attention.” is given to the generative AI, and a sign of abnormality and an operation abnormality are automatically detected. Specifically, the present system containerizes each functional module and dynamically allocates resources using an orchestration tool. The robot operation status monitoring unit acquires, as input data, a time-series tensor indicating a joint angle of each robot, a one-dimensional array indicating current consumption of a motor, and a numerical vector indicating biological information of a worker. The monitoring unit converts time-series data into spectrum data in a frequency domain using fast Fourier transform as preprocessing. The monitoring unit inputs this spectrum data to a convolutional neural network and extracts a feature map. The monitoring unit converts the extracted feature map into a text embedding to be embedded in a prompt of a large language model. The monitoring unit outputs, as output data, a floating-point number indicating an abnormality probability of each robot, a classification label specifying a root cause of an abnormality, and a natural language text indicating a specific coping procedure. The monitoring unit outputs a text indicating that, for example, noise in a high-frequency band increases in a third joint motor of a robot O and a probability of bearing wear is 94 percent. The monitoring unit outputs an action plan to, for example, immediately safely stop the robot O and dispatch a maintenance person in charge P. The monitoring unit broadcasts this output result to other modules via a data bus. The monitoring unit generates a hardware interrupt signal when the abnormality probability exceeds a threshold value. The monitoring unit thereby avoids a fatal failure with a response speed in milliseconds. The monitoring unit captures a minute physical change that cannot be captured by human vision or hearing. The monitoring unit is applied to use cases such as a processing factory frequently using high-speed rotating equipment and a precision transport system in a clean room.

The work allocation optimization unit comprehensively analyzes the data acquired by the robot operation status monitoring unit and the skill (welding, assembly, inspection, transport, painting, picking, screw tightening, soldering, quality inspection, image recognition, etc.), workload, operation state, maintenance history, parts supply status, task priority, process progress, and site layout of each robot, and the skill, workload, health condition, and vacation schedule of a worker, and realizes flexible scheduling such as, for example, preferentially allocating a robot having a welding skill, operating, and having a low workload to a welding task, avoiding allocation of a robot having an assembly skill but requiring maintenance recently, preferentially allocating an inspection task to a worker having abundant failure response experience, allocating a transport task to a robot closest on the site layout, allocating a picking task to a robot having high AI image recognition accuracy, preferentially allocating a robot having a high operation rate at night or on a holiday, automatically generating a reasonable shift in consideration of the health condition and vacation schedule of the worker, executing recalculation of allocation and reallocation in real time according to a progress of an ongoing task and a change in a site situation (parts supply delay, sudden failure of a robot, sudden poor physical condition of a worker, site layout change, occurrence of a bottleneck between processes, etc.), temporarily stopping a task of a corresponding process and reallocating resources to another process when a parts supply delay occurs, for example, automatically changing allocation to another robot or worker immediately when a sudden failure of a robot occurs, recommending a break and reallocating a task to another worker or robot when poor physical condition of a worker is detected, recalculating a shortest flow line and optimizing a transport task when a site layout is changed, and dynamically adjusting resource allocation between processes when a bottleneck between processes occurs. A prompt sentence such as “Propose an optimal work allocation plan and scheduling based on the following robot/worker skill, operation state, workload, maintenance history, parts supply status, task priority, process progress, site layout, health condition, and vacation schedule.” is given to the generative AI. Specifically, the work allocation optimization unit solves a complex constraint satisfaction problem using a large language model combined with deep reinforcement learning. The optimization unit acquires, as input data, a multidimensional state matrix indicating current states of all resources in the factory, directed acyclic graph data indicating a dependency relationship of each task, and a weight vector indicating a dynamically changing priority. The optimization unit converts the dependency relationship between tasks into a low-dimensional node embedding vector using a graph neural network as preprocessing. The optimization unit combines these vectors into a prompt template and inputs them to the language model. The optimization unit outputs, as output data, a binary allocation matrix indicating mapping of resources and tasks at each time step, a node list indicating a critical path of a schedule, and a natural language text explaining a reason for recalculation. The optimization unit outputs an allocation matrix indicating that, for example, a robot Q is allocated to a task R and a worker S is allocated to a task T. The optimization unit outputs an explanatory text indicating that, for example, a process V is temporarily stopped due to a supply delay of a part U and resources are reallocated to a process W. The optimization unit transmits this output result to a task queue of each robot and a smart glass of a worker. The optimization unit recalculates the allocation matrix on the order of milliseconds every time a change in the site situation is detected. The optimization unit dynamically extracts the most important element from an enormous amount of constraint conditions using an attention mechanism. The optimization unit thereby derives a global optimal solution while avoiding combinatorial explosion. The optimization unit realizes dynamic resource allocation on a scale that cannot be calculated by a human scheduler. The optimization unit is applied to use cases such as an agile manufacturing line performing high-mix low-volume production and a large-scale fulfillment center.

The maintenance management optimization unit analyzes an operation time, the number of days elapsed since the last maintenance, a failure occurrence history, an operation pattern, a replacement parts history, a skill of a maintenance worker, a maintenance work time, an operation status after maintenance, a maintenance cost, a maintenance parts inventory, and the like of each robot, notifies a robot whose operation time exceeds a specified value of “maintenance recommended”, for example, issues an alert “emergency maintenance recommended” to a robot in which failures frequently occur recently, learns a maintenance history and a failure occurrence pattern, extracts a tendency such as a failure occurrence rate decreasing after replacement of a specific part, failures frequently occurring under a specific work condition, and operation stability after maintenance differing depending on the skill of the maintenance worker, proposes optimal maintenance contents and timing, worker allocation, and advance preparation of maintenance parts, records a progress and a result of maintenance work, and reflects them in a maintenance plan from the next time onward. A prompt sentence such as “Propose optimal maintenance timing, maintenance contents, person in charge allocation, and parts replenishment plan based on the following robot operation time, maintenance history, failure occurrence history, replacement parts history, maintenance worker skill, and maintenance parts inventory.” is given to the generative AI. Specifically, the maintenance management optimization unit implements a prediction engine in which a reliability engineering model using a Weibull distribution and deep learning are fused. The optimization unit acquires, as input data, a multidimensional time-series tensor indicating a deterioration state of each part, a text embedding vector extracted from a past maintenance report, and a two-dimensional array indicating a skill matrix of a maintenance worker. The optimization unit performs principal component analysis on the time-series tensor as preprocessing to construct a feature space from which noise is removed. The optimization unit inputs data of this feature space to a transformer encoder. The optimization unit outputs, as output data, a continuous value vector indicating a remaining life of each part, a categorical label of a recommended maintenance action, and an ID list of a worker optimal for maintenance work. The optimization unit outputs a continuous value indicating that, for example, a remaining life of a speed reducer of a robot X is 400 hours. The optimization unit outputs specific schedule data to, for example, arrange a worker Y in a non-operation time zone this weekend and execute an overhaul. The optimization unit writes this output result in a maintenance management database and automatically registers a schedule in a calendar application of a related worker. The optimization unit receives operation data after execution of maintenance as feedback and finely adjusts a weight of a prediction model. The optimization unit thereby continuously improves prediction accuracy of the model. The optimization unit establishes data-driven predictive maintenance that does not depend on human rules of thumb. The optimization unit prevents an enormous opportunity loss due to a sudden failure. The optimization unit is applied to use cases requiring extremely high reliability, such as an aircraft engine maintenance factory and turbine maintenance of a large-scale power plant.

The parts supply monitoring unit monitors and analyzes an inventory status, a consumption pace, a supply delay, quality data, supplier information, an ordering history, a delivery history, a lot number of a part, an expiration date, a storage location, traceability information of a part, and the like for each part, notifies “replenishment of part A recommended” when the inventory of part A becomes less than 10, for example, issues an alert “supply delay of part B, process adjustment recommended” when the supply of part B is delayed from a schedule, learns a consumption pace and a past supply history, extracts a pattern such as consumption of part C tending to increase on weekends and part D having a high defective rate in a specific process, automatically generates a replenishment plan and a supplier review in advance, refers to quality data as well, proposes suspension of use of a corresponding lot and a claim to a supplier when a defective rate is increasing in a specific lot of part E, and recommends priority consumption when an expiration date of part F is near. A prompt sentence such as “Propose a replenishment plan, an ordering plan, a supplier review plan, and a quality improvement plan based on the following parts inventory, consumption pace, supply delay, quality data, supplier information, ordering history, delivery history, lot number, expiration date, storage location, and traceability information.” is given to the generative AI. Specifically, the parts supply monitoring unit models a network structure of the entire supply chain using a graph convolutional network. The monitoring unit acquires, as input data, an integer vector indicating a real-time inventory amount of each part, a spatial data tensor indicating geographical coordinates of a supplier and a transportation lead time, and a floating-point array indicating a quality inspection score of each lot. The monitoring unit converts these data into directed graph data composed of nodes and edges as preprocessing. The monitoring unit inputs this graph data to a multi-layer graph attention network. The monitoring unit outputs, as output data, heat map data indicating a future inventory depletion probability at each node, a matrix indicating optimal ordering timing and quantity, and a natural language text pointing out a bottleneck of the supply chain. The monitoring unit outputs a probability score indicating that, for example, a probability that the inventory of part Z is depleted within 48 hours is 89 percent. The monitoring unit outputs an action plan to, for example, immediately order from an alternative supplier Beta because delivery from a supplier Alpha is delayed. The monitoring unit transmits this output result to an ERP system via an API and automatically generates an order form. The monitoring unit issues a control command for physically isolating a corresponding lot to an automated warehouse system when detecting a lot whose quality score has decreased. The monitoring unit thereby prevents outflow of defective products at the border. The monitoring unit optimizes dynamics of a complex supply chain exceeding human management capability in real time. The monitoring unit is applied to use cases such as an automobile manufacturer procuring parts globally and a food processing factory requiring strict management of expiration dates.

The quality analysis unit multilaterally analyzes quality data, the number of defective product occurrences, an inspection result, a past quality trouble history, a parts supply history, an assignment history of a worker or a robot, quality comparison between processes, a quality cost, feedback from a customer, a quality audit result, a quality improvement activity history, and the like associated with each process or task, recommends a review of a work procedure in an assembly process, proposes retraining of a person in charge, recommends an accuracy inspection of a corresponding robot, and issues an improvement plan such as a review of a parts supply route, a supplier change, and introduction of an additional inspection process when defective products frequently occur in the assembly process, for example, proposes a traceability investigation of a parts lot, a quality improvement request to a supplier, introduction of an additional inspection process, and the like when defects are concentrated on a specific part in an inspection process, and immediately notifies a manager or a site supervisor of a quality warning and an improvement proposal through the report generation unit. A prompt sentence such as “Propose identification of a quality problem, an improvement plan, a reassignment plan, a quality education plan, and a quality cost reduction plan based on the following quality data, number of defective product occurrences, inspection result, quality trouble history, parts supply history, assignment history, comparison between processes, quality cost, customer feedback, audit result, and improvement activity history.” is given to the generative AI. Specifically, the quality analysis unit implements a hybrid inference engine combining a causal inference algorithm and a large language model. The analysis unit acquires, as input data, a multidimensional feature vector extracted from sensor data of each manufacturing process, a binary label array indicating a final inspection result of a product, and an embedding vector of a claim text from a customer. The analysis unit constructs a causal relationship graph between respective variables using a Bayesian network as preprocessing. The analysis unit inputs this causal relationship graph and text data to a prompt of the language model. The analysis unit outputs, as output data, a probabilistic inference result indicating a root cause of defect occurrence, a node importance score specifying a cause location, and a structured text describing a specific quality improvement measure. The analysis unit outputs an inference result indicating that, for example, a probability that insufficient torque of a robot in an assembly process Gamma causes a joint defect of a product is 95 percent. The analysis unit outputs an improvement measure to, for example, increase a torque setting value of the robot by 3 Newton meters and add a 100% inspection of a corresponding lot. The analysis unit transmits this output result to a robot control system and automatically corrects a torque parameter. The analysis unit compares data before and after implementation of the improvement measure and continuously evaluates accuracy of a causal model. The analysis unit eliminates an erroneous countermeasure based on a spurious correlation by clearly distinguishing between a correlation and a causal relationship. The analysis unit elucidates a complex causal relationship in a high-dimensional data space and dramatically improves accuracy of quality management. The analysis unit is applied to use cases such as a semiconductor wafer manufacturing process requiring accuracy in nanometers and a manufacturing line of a medical implant related to human life.

The report generation unit generates a detailed report including an operation status of the entire factory, work progress, a maintenance status, a parts supply status, a quality status, an abnormality detection content, an optimization proposal, an improvement history, cost analysis, comparison between processes, feedback from a site, future prediction by AI, and the like based on analysis results of the respective units, creates a report summarizing, for example, an operation rate transition for each robot, a progress status for each task, a maintenance implementation history and a future maintenance schedule, a parts inventory transition and a replenishment history, a time-series transition of quality data, the number of abnormality detections and a response history, a list of optimization proposals by AI, a transition of a quality cost, quality comparison between processes, an improvement proposal from the site and its implementation status, future quality/operation prediction by AI, and the like on a daily, weekly, or monthly basis, enables real-time browsing on a site terminal or a dashboard for a manager, and notifies by a chat tool, an email, or the like as necessary. A prompt sentence such as “Create a report summarizing an operation status of the entire factory, progress, maintenance, parts supply, quality, abnormality, optimization proposal, improvement history, cost, comparison between processes, feedback, and future prediction based on the following analysis results of the respective units.” is given to the generative AI. Specifically, the report generation unit uses a generative neural network having a multimodal data integration function. The generation unit acquires, as input data, a numerical matrix output from each analysis unit, an image tensor of a time-series graph, and an insight text in a natural language. The generation unit serializes these data into a hierarchical JSON structure as preprocessing. The generation unit inputs this structured data to a context window of a large language model. The generation unit calculates an appearance probability of a word through an autoregressive decoding process. The generation unit outputs, as output data, a summary text for a management layer, a detailed drill-down data structure for a site manager, and a dynamic HTML code for dashboard drawing. The generation unit outputs a summary text indicating that, for example, production efficiency of the entire factory this month exceeds a target value by 5 percent, and optimization of a process Delta particularly contributed. The generation unit outputs a prediction text indicating that, for example, a resource shortage risk based on an operation prediction for next week is less than 10 percent. The generation unit push-distributes this output result to a browser engine of each terminal via an internal network. The generation unit analyzes a browsing history and clickstream data of a user and personalizes display contents at the time of next report generation. The generation unit completely automates a routine report creation task and shifts human working hours to a high value-added decision-making task. The generation unit extracts a semantic structure recognizable by a human from an enormous amount of log data. The generation unit is applied to use cases such as integration with an enterprise resource planning system supervising a plurality of production bases and automatic generation of an environmental, social, and governance report for shareholders.

The user interface unit provides a function enabling a site worker or a manager to browse, confirm, and input a progress status, task allocation, resource allocation, risk information, a proposal content from the generative AI, a report, and the like in real time from a PC, a tablet, a smartphone, a wearable terminal, or the like through a dashboard screen or a chat tool, and for example, a progress graph of the entire project, a task list, a progress status by person in charge, a resource consumption status, a risk list, a comparison graph with past data, a proposal content from the generative AI, an action item list, a notification history, a comment field, a file attachment field, and the like are displayed on the dashboard screen. Specifically, the user interface unit is implemented as a front-end system adopting a single-page application architecture. The interface unit acquires, as input data, coordinate data of a touch event transmitted from a user terminal, an audio waveform tensor from a voice input microphone, and an image array for line-of-sight tracking from a camera. The interface unit converts voice data into text and calculates a user's attention area from line-of-sight data as preprocessing. The interface unit asynchronously transmits these input data to a back-end AI model. The interface unit outputs, as output data, a dynamic DOM tree according to an authority level of a user, rendering data for augmented reality superimposed and displayed in a three-dimensional space, and feedback voice by a voice synthesis engine. The interface unit outputs voice data indicating that, for example, a current task progress rate is 75 percent. The interface unit draws a virtual arrow object indicating a position of a part to be picked next on a display of a smart glass, for example. The interface unit executes redrawing of a screen at a frame rate of 60 hertz or more using this output result. The interface unit maintains bidirectional real-time data synchronization with a server using WebSocket communication. The interface unit thereby significantly reduces a cognitive load of a site worker. The interface unit eliminates a conventional input method using a keyboard or a mouse and provides an intuitive human-machine interface. The interface unit is applied to use cases requiring non-contact operation in an assembly work site where both hands are occupied or in a clean room.

The notification management unit has a function of automatically distributing a progress report, a risk warning, a proposal content from the generative AI, and the like to related parties by combining a plurality of notification means such as a group chat and an individual chat of a chat tool, a notification column of a dashboard, an email notification, a push notification, and calendar cooperation, and operations are possible such as, for example, immediately notifying a person in charge and a manager when a progress delay occurs, transmitting a warning notification to all the related parties when a risk increases, displaying an action plan proposal from the generative AI on the dashboard, and distributing a weekly progress report to all members by email. Specifically, the notification management unit implements a messaging queue system based on a publish-subscribe model. The notification management unit acquires, as input data, an event payload issued from each analysis module, a GPS coordinate vector indicating a current position of a user, and a status code indicating a current presence state of the user. The notification management unit calculates an importance score of an event as preprocessing and collates the importance score with context information of the user. The notification management unit inputs this collation result to a rule engine and a small-scale decision tree model. The notification management unit outputs, as output data, a routing tag for selecting an optimal distribution channel, a time stamp indicating a notification timing, and a message text optimized for a format of each channel. The notification management unit immediately transmits, for example, a short message that an abnormal stop has occurred in a line A with high urgency to a smartphone of a site manager. The notification management unit delays and transmits, for example, a notification that a weekly report with low importance has been generated to a queue of an email server. The notification management unit distributes this output result via various external APIs. The notification management unit collects tracking data on whether or not the user has opened the notification, and uses the tracking data for optimization of next distribution logic. The notification management unit prevents alert fatigue due to information overload and transmits only truly important information at an appropriate timing. The notification management unit suppresses wasteful consumption of a communication band and improves network efficiency of the entire system. The notification management unit is applied to use cases such as an emergency contact network in a steelworks having a vast site and asynchronous communication between globally distributed teams.

The data integration unit integrates data from various sensors, a control system, an MES, a SCADA, a site terminal, a worker input device, a parts management system, a quality management system, an external procurement system, and the like, performs data normalization, time-series matching, abnormal value removal, data missing complementation, data mapping, data anonymization, and the like, and generates a data set optimal for AI analysis. Specifically, the data integration unit constructs a data pipeline architecture that automates an extraction, transformation, and loading process. The data integration unit acquires, as input data, a heterogeneous time-series data stream having different sampling rates, a structured query result from a relational database, and an unstructured text log. The data integration unit synchronizes phases of asynchronous time-series data using a dynamic time warping algorithm as preprocessing. The data integration unit removes sensor noise using a Kalman filter and estimates a missing value by spline interpolation. The data integration unit converts these data into a common multidimensional tensor format. The data integration unit outputs, as output data, a normalized feature amount matrix perfectly conforming to input requirements of a machine learning model, an anonymized text corpus in which personal information is masked, and metadata indicating a quality score of the data. The data integration unit generates, for example, floating-point matrix data of 1000 rows and 100 columns and arranges the floating-point matrix data in a shared memory space. The data integration unit outputs, for example, a log file in which a worker name is hashed. The data integration unit stores this output result in a distributed file system or an in-memory database to enable high-speed reading from a subsequent AI module. The data integration unit completely automates complicated data cleansing work manually performed by a data scientist. The data integration unit ensures inference accuracy of a downstream AI model by continuous supply of a high-quality data set. The data integration unit is applied to use cases such as IoT implementation of a legacy factory in which hundreds of different protocols are mixed and a secure data cooperation platform between companies.

The AI prompt management unit performs management, optimization, history management, automatic generation of a prompt template, multilingual support of a prompt sentence, version management of a prompt sentence, and the like for a prompt sentence given to the generative AI in each unit, automatically selects and edits an optimal prompt sentence according to, for example, a site situation and an analysis purpose, and improves accuracy and flexibility of AI analysis. Specifically, the AI prompt management unit implements a prompt engineering system combining a vector database and a retrieval-augmented generation technology. The management unit acquires, as input data, a context vector indicating an analysis request from each module, an evaluation score array of past prompt execution results, and a locale code indicating a language setting of a user. The management unit calculates a cosine similarity between the context vector and an existing prompt template in the vector database as preprocessing. The management unit extracts the most appropriate template based on this similarity calculation. The management unit outputs, as output data, an optimized prompt character string in which a variable is dynamically embedded, an integer value indicating the number of tokens of the prompt, and a parameter setting group of a language model to be used. The management unit defines a role as a system prompt, for example, and outputs a text of thousands of tokens in which latest sensor data is embedded in a JSON format as a user prompt. The management unit outputs a setting value that sets a temperature parameter to 0.2, for example, and forces a deterministic output. The management unit transmits this output result to an inference API of a large language model. The management unit evaluates validity of an output result from the language model and feeds back the evaluation value to a version management system of the prompt. The management unit autonomously evolves a configuration of the prompt using reinforcement learning. The management unit eliminates manual prompt tuning by a human and always draws out an optimal inference result. The management unit is applied to use cases such as a production base of a multinational corporation where multiple languages fly about and an agile development environment where task requirements frequently change.

In this way, the system according to the present embodiment can optimize an operation status, work allocation, maintenance management, parts supply, quality management, process improvement, site feedback, future prediction, and the like of robots and workers in a factory in real time and automatically by cooperation of the respective units, and can realize improvement in productivity and quality at a site, reduction in downtime and a defective rate, significant reduction in human burden, and company-wide sharing of site knowledge. Specifically, the system functions as a central control orchestrator that integrates all the functional modules described above. The system acquires, as input data, a state update vector asynchronously transmitted from each module, an environmental index tensor indicating power consumption and carbon dioxide emissions of the entire factory, and a KPI matrix indicating a management target. The system normalizes these macro indices and integrates them into a single objective function as preprocessing. The system dynamically adjusts hyperparameters of the entire system using an evolutionary algorithm in order to maximize this objective function. The system outputs, as output data, an index value indicating an autonomous control level of the entire factory, a weight vector indicating a resource allocation ratio of a next cycle, and a health check log indicating soundness of the entire system. The system outputs a status that the autonomous control level has reached a fully autonomous state of level 5, for example. The system outputs a control command to increase calculation resource allocation to a maintenance module by 20 percent, for example. The system transmits this output result to a management plane of a cloud infrastructure and executes auto-scaling of a container. The system realizes emergent global optimization as the entire system, not a collection of individual optimizations. The system draws out computing power of a computer to the limit and breaks through a limit of a physical manufacturing process. The system is applied to use cases such as a next-generation fully unmanned factory and a global manufacturing network aiming at supply chain optimization on a global scale.

### Implementation Steps

Step 1: Collection of Robot/Worker Operation Data Diverse data such as operation states, skills, workloads, maintenance histories, failure occurrence statuses, work progresses, task dependencies, priorities, difficulties, man-hour estimates, and quality evaluations of robots and workers are aggregated to a server in real time or periodically from various sensors, a robot control system, an MES, a SCADA, a site terminal, a worker input device, and the like in a factory. For example, states such as operating, waiting, stopped, under maintenance, and abnormally stopped, an operation rate for the latest one hour, a cumulative operation time, a continuous operation time, a maintenance history, a failure occurrence date and time/content/response history, a task progress rate, a start date and time/scheduled end date and time, a delay status, a person in charge/robot in charge, a quality evaluation, and the like are acquired. Specifically, the data collection unit operates in cooperation with an edge computing device. The data collection unit receives an analog signal from a high-frequency vibration sensor or a current sensor installed in each robot. The data collection unit converts the received analog signal into digital data at a sampling frequency of 10,000 hertz. The data collection unit executes a fast Fourier transform on the converted digital data. The data collection unit extracts a feature amount in a frequency domain. The data collection unit normalizes the extracted feature amount. The data collection unit stores the normalized feature amount in a memory as a 256-dimensional numerical vector. The data collection unit receives text data from an input device of a worker. The data collection unit converts the text data into a word embedding vector using a natural language processing model. The data collection unit digitizes a categorical variable indicating an operation state of the robot by one-hot encoding. The data collection unit integrates these heterogeneous data. The data collection unit configures the integrated data as a time-series tensor together with a time stamp. The time-series tensor is a third-order tensor of a batch size, the number of time steps, and the number of feature amount dimensions. The data collection unit transmits the configured time-series tensor to a distributed database of a central server by asynchronous communication. The system applies a data compression algorithm at the time of data transmission. The system minimizes consumption of a network band. The system executes a missing value complementation algorithm. The system restores missing data due to a temporary communication disconnection of a sensor by linear interpolation. The system applies a noise removal filter. The system excludes an abnormal value due to a sudden disturbance. The system executes these preprocessings on an edge side. The system significantly reduces a calculation load on the central server. The system establishes a real-time data processing pipeline. The system completely eliminates conventional manual data collection work. The system shortens a delay in data collection to a millisecond unit. The system enables highly accurate analysis by a subsequent artificial intelligence model. As a technical effect, the system reproduces an operation status of the entire factory in a digital space without delay. The system facilitates construction of a digital twin. As a specific application field, the system functions extremely effectively in a large-scale manufacturing base such as a semiconductor manufacturing factory or an automobile assembly line.

Step 2: AI Analysis of Operation Status and Sign of Abnormality The collected operation data and progress data are read into the generative AI, and a decrease in an operation rate, a sign of an abnormal stop, an excess of a continuous operation time, a frequent failure tendency, a stress sign of a worker, and the like are automatically extracted using anomaly detection, time-series analysis, pattern recognition, causal inference, and the like. A specific example of a prompt sentence to be read into the generative AI is “Analyze the following robot operation data, workload, maintenance history, failure occurrence status, and work progress data, and extract a sign of abnormality and an operation abnormality. If there is a decrease in an operation rate or a sign of an abnormal stop, point it out and list robots requiring attention.” Specifically, the anomaly detection unit implements a complex neural network combining a long short-term memory network and an autoencoder. The anomaly detection unit inputs the third-order time-series tensor generated in the previous paragraph to the complex neural network. The input data includes a vibration frequency vector of a robot, a fluctuation vector of a current value, and a heart rate fluctuation vector of a worker for the past 72 hours. The number of dimensions of the input data is, for example, a batch size of 64, 128 time steps, and 512 feature amount dimensions. The complex neural network compresses the input time-series tensor into a low-dimensional latent space. The complex neural network reconstructs the original time-series tensor from the compressed latent representation. The complex neural network calculates a mean square error between the input tensor and the reconstructed tensor. The anomaly detection unit outputs this reconstruction error as an anomaly score. The output data is an anomaly probability score of a continuous value from 0 to 1 for each robot and each worker. As a specific example of the output data, an anomaly probability score of a robot A is 0.85. A stress sign score of a worker B is 0.92. A normal operation score of a robot C is 0.11. The anomaly detection unit compares the output anomaly probability score with a preset dynamic threshold. The anomaly detection unit sets a sign of abnormality flag when the score exceeds the threshold. The anomaly detection unit transmits this flag to a subsequent optimal work allocation unit and maintenance management optimization unit. The system uses a large language model in combination. The system generates a detailed text report for a target for which the sign of abnormality flag is set. The system uses a prompt tensor in which an anomaly score, a part of corresponding time-series data, and a system log are concatenated as an input of the large language model. The system generates a token sequence of a natural language estimating a root cause of an anomaly as an output of the large language model. The system displays the generated text on a dashboard of a manager. As a technical effect, the system detects a sign of a minute anomaly that cannot be found by human visual inspection or a simple rule base at an early stage by a nonlinear operation in a high-dimensional space. The system prevents a sudden equipment stop. The system dramatically reduces downtime of a factory. As a specific application field, the system is applicable to piping monitoring of a chemical plant, tool wear prediction of a precision machining line, and the like.

Step 3: AI Optimization of Optimal Work Allocation and Scheduling Skills, workloads, operation states, maintenance histories, parts supply statuses, task priorities, process progresses, a site layout, health conditions and vacation schedules of workers, and the like of robots and workers are read into the generative AI, and an optimal work allocation plan and scheduling are automatically generated. Recalculation and reallocation are executed in real time according to an ongoing task and a change in a site situation. A specific example of a prompt sentence to be read into the generative AI is “Propose an optimal work allocation plan and scheduling based on the following robot/worker skills, operation states, workloads, maintenance histories, parts supply statuses, task priorities, process progresses, site layout, health conditions, and vacation schedules.” Specifically, the optimal work allocation unit executes a scheduling agent based on a deep reinforcement learning algorithm. The optimal work allocation unit encodes a current state in a factory as a state vector. The state vector is a 1024-dimensional numerical vector including current position coordinates of each robot, a fatigue score of each worker, remaining man-hours of each task, and the number of parts in stock. The optimal work allocation unit inputs this state vector to a policy network of the scheduling agent. The policy network is composed of a multilayer perceptron. The policy network nonlinearly transforms the input state vector in a hidden layer. The policy network outputs a probability distribution of optimal resource allocation for each task. The output data is a two-dimensional matrix indicating an allocation probability for a pair of a task and a resource. As a specific example of the output data, a probability of allocating a task 1 to a robot 2 is 95 percent. A probability of allocating a task 2 to a worker 3 is 88 percent. A probability of allocating a task 3 to a robot 1 is 12 percent. The optimal work allocation unit selects an allocation action with the highest probability from the output probability distribution. The optimal work allocation unit updates a schedule of the factory based on the selected action. The optimal work allocation unit evaluates the updated schedule in a simulation environment. The optimal work allocation unit calculates a reward function aiming at minimization of a total completion time and leveling of a resource operation rate. The optimal work allocation unit updates a weight parameter of the policy network by a proximal policy optimization algorithm using the calculated reward value. The optimal work allocation unit detects a change in a site situation in a millisecond unit. The optimal work allocation unit immediately reconstructs the state vector. The optimal work allocation unit executes recalculation in real time. As a technical effect, the system solves a scheduling problem accompanied by a huge combinatorial explosion at high speed and optimally by deep reinforcement learning. The system realizes dynamic and flexible resource allocation impossible with a conventional method. The system dramatically improves overall production efficiency. As a specific application field, the system is applied to optimization of picking work in an assembly factory performing high-mix low-volume production or a large-scale logistics warehouse.

Step 4: AI Optimization Proposal of Maintenance Timing and Content An operation time, the number of days elapsed since the last maintenance, a failure occurrence history, a replacement parts history, a maintenance worker skill, a maintenance parts inventory, and the like of each robot are read into the generative AI, and optimal maintenance timing, a maintenance content, person-in-charge allocation, and a parts replenishment plan are automatically proposed. A specific example of a prompt sentence to be read into the generative AI is “Propose optimal maintenance timing, a maintenance content, person-in-charge allocation, and a parts replenishment plan based on the following robot operation time, maintenance history, failure occurrence history, replacement parts history, maintenance worker skill, and maintenance parts inventory.” Specifically, the maintenance management optimization unit implements a deep neural network based on survival time analysis. The maintenance management optimization unit extracts a past operation history and sensor data of each robot as an input feature amount. The input feature amount is a 128-dimensional numerical vector including a cumulative operation time, an average temperature, a maximum vibration amplitude, and the number of past parts replacements. The maintenance management optimization unit inputs this numerical vector to the deep neural network. The deep neural network includes an output layer that estimates a parameter of a Weibull distribution. The deep neural network outputs a future failure probability density function of each robot from the input numerical vector. The output data is a time-series array indicating a failure occurrence probability on each day for the next 30 days. As a specific example of the output data, a failure probability of a robot A after 3 days is 15 percent. A failure probability of a robot B after 10 days is 42 percent. A failure probability of a robot C after 20 days is 89 percent. The maintenance management optimization unit integrates this failure probability density function. The maintenance management optimization unit specifies a day when a cumulative failure probability exceeds a preset threshold as optimal maintenance timing. The maintenance management optimization unit collates the specified maintenance timing with current parts inventory data. The maintenance management optimization unit generates a list of necessary replacement parts. The maintenance management optimization unit refers to a skill matrix of maintenance workers. The maintenance management optimization unit allocates a worker most suitable for target maintenance work. The maintenance management optimization unit integrates these pieces of information. The maintenance management optimization unit outputs maintenance instruction data in a structured JSON format. The maintenance management optimization unit automatically transmits this maintenance instruction data to a maintenance management system of a factory. As a technical effect, the system realizes a transition from periodic preventive maintenance to data-driven predictive maintenance. The system reduces unnecessary parts replacement. The system significantly reduces a maintenance cost. The system minimizes a production stop risk due to an unexpected equipment failure. As a specific application field, the system is applicable to operation of infrastructure equipment requiring high reliability, such as engine maintenance of an aircraft and turbine maintenance management of a power plant.

Step 5: AI Monitoring and Proposal of Parts Supply Status and Quality A parts inventory, a consumption pace, a supply delay, quality data, supplier information, an ordering history, a delivery history, a lot number, an expiration date, a storage location, traceability information, and the like are read into the generative AI, and a replenishment plan, an ordering plan, a supplier review plan, and a quality improvement plan are automatically generated. A specific example of a prompt sentence to be read into the generative AI is “Propose a replenishment plan, an ordering plan, a supplier review plan, and a quality improvement plan based on the following parts inventory, consumption pace, supply delay, quality data, supplier information, ordering history, delivery history, lot number, expiration date, storage location, and traceability information.” Specifically, the parts supply monitoring unit executes a supply chain optimization model using a graph neural network. The parts supply monitoring unit constructs graph structure data having a parts inventory, a supplier, a transportation route, and a production line in a factory as nodes. The parts supply monitoring unit assigns a feature amount vector to each node. The input data is a 256-dimensional node feature amount matrix including the current number of parts in stock, an average consumption speed for the past one week, a past delivery delay rate of a supplier, and a defective product occurrence rate for each lot. The parts supply monitoring unit inputs this graph structure data and the node feature amount matrix to the graph neural network. The graph neural network executes a message passing algorithm. The graph neural network aggregates information between adjacent nodes. The graph neural network updates a hidden state of each node. The graph neural network outputs an optimal ordering amount and ordering timing for each part. The output data is structured data including a part identifier, a recommended ordering quantity, and a recommended ordering date. As a specific example of the output data, a recommended ordering quantity of a part X is 500 and a recommended ordering date is today. A recommended ordering quantity of a part Y is 1000 and a recommended ordering date is 3 days later. A supplier change recommendation flag of a part Z is true. The parts supply monitoring unit transfers the output structured data to a purchasing management system. The purchasing management system automatically generates an order form based on the recommended ordering quantity. The purchasing management system transmits the order form to a system of the supplier via an electronic data interchange protocol. When an abnormality is detected in the quality data, the parts supply monitoring unit specifies a corresponding lot number. The parts supply monitoring unit traces back the traceability information. The parts supply monitoring unit issues an alert specifying a supplier or a manufacturing process that caused the abnormality. As a technical effect, the system models dynamics of a complexly intertwined supply chain as a graph structure. The system accurately predicts an influence of a local inventory shortage or supply delay on the whole. The system eliminates excess and deficiency of inventory to the limit. The system improves cash flow. As a specific application field, the system is applied to inventory management in an automobile manufacturing industry handling tens of thousands of parts and a food processing industry in which expiration date management is strict.

Step 6: Multilateral AI analysis of quality data and presentation of improvement plan. Quality data, the number of defective product occurrences, an inspection result, a past quality trouble history, a parts supply history, an assignment history, an inter-process comparison, a quality cost, customer feedback, an audit result, an improvement activity history, and the like associated with each process or task are read into the generative AI, identification of a quality problem, an improvement plan, a reassignment plan, a quality education plan, and a quality cost reduction plan are automatically generated, and a quality warning and an improvement proposal are immediately notified. A specific example of a prompt sentence to be read into the generative AI is “Propose identification of a quality problem, an improvement plan, a reassignment plan, a quality education plan, and a quality cost reduction plan based on the following quality data, number of defective product occurrences, inspection result, past quality trouble history, parts supply history, assignment history, inter-process comparison, quality cost, customer feedback, audit result, and improvement activity history.” Specifically, the quality analysis unit adopts a multimodal artificial intelligence architecture integrating a convolutional neural network and a transformer model. The quality analysis unit receives surface image data of a product acquired from an inspection camera as an input tensor. The number of dimensions of the image data is, for example, a three-channel color image with a resolution of 1024 by 1024. The quality analysis unit extracts a visual feature vector from the image data using the convolutional neural network. The quality analysis unit simultaneously inputs customer feedback and audit result data in a text format to a natural language processing model. The quality analysis unit extracts a semantic feature vector from the text data. The quality analysis unit combines the visual feature vector and the semantic feature vector. The quality analysis unit inputs this combined vector to the transformer model. The transformer model learns a hidden correlation between different data sources using a self-attention mechanism. The transformer model outputs a probability distribution classifying a root cause of quality degradation. The output data is a vector indicating a probability value for each cause category. As a specific example of the output data, a probability that the cause is a dimensional defect of a part is 75 percent. A probability that the cause is insufficient torque of an assembly robot is 20 percent. A probability that the cause is a procedural error of a worker is 5 percent. The quality analysis unit generates a specific improvement action plan based on this output result. The quality analysis unit push-notifies the generated action plan to a terminal of a related department. The quality analysis unit analyzes a transition of the quality cost in time series. The quality analysis unit quantitatively evaluates an investment-to-effect ratio of the improvement activity. As a technical effect, the system integrally analyzes different modalities of image data and text data. The system identifies a root cause of a complex quality problem, which tends to be overlooked by a single data source, with high accuracy. The system realizes automation and sophistication of a quality assurance process. As a specific application field, the system is applicable to a manufacturing line of electronic parts where a minute defect is fatal, and an assembly process of medical equipment requiring high safety standards.

Step 7: Report generation and site distribution. Based on the AI analysis results of the respective units, a detailed report summarizing an operation status of the entire factory, work progress, a maintenance status, a parts supply status, a quality status, an abnormality detection content, an optimization proposal, an improvement history, a cost analysis, an inter-process comparison, site feedback, a future prediction, and the like is generated, and automatically distributed to a manager or a site supervisor via a dashboard, a chat tool, an email, or the like. A specific example of a prompt sentence to be read into the generative AI is “Create a report summarizing the operation status of the entire factory, progress, maintenance, parts supply, quality, abnormality, optimization proposal, improvement history, cost, inter-process comparison, feedback, and future prediction based on the following analysis results of the respective units.” Specifically, the report generation unit functions with a large language model having tens of billions of parameters as a core. The report generation unit collects numerical data, a probability score, and categorical data output from each analysis unit. The report generation unit embeds these structured data into a natural language prompt template. The input data is a context vector extending to thousands of tokens aggregated from all systems in the factory. As a specific example of the input data, numerical data that the overall equipment effectiveness is 85 percent and a score that the abnormality probability of the robot A is 90 percent are included. The large language model processes this context vector. The large language model sequentially calculates a probability distribution of a next word through an autoregressive decoding process. The large language model generates a natural language report text that is easy for humans to understand. The output data is text data structured in a markdown format. As a specific example of the output data, an operation summary of the entire factory is described in Chapter 1. A detected abnormality and its recommended countermeasure are described in Chapter 2. A production prediction for the next week and a resource allocation plan are described in Chapter 3. The report generation unit converts the generated text data into an HTML format. The report generation unit deploys the converted data to a web server on an internal network. The report generation unit simultaneously extracts a section including abnormality information with high urgency. The report generation unit immediately transmits the section as a short message to a mobile terminal of the site supervisor. The report generation unit executes a distribution routing algorithm. The report generation unit dynamically filters the content of the report according to a job title and an assigned area of a recipient. As a technical effect, the system converts an output result of a massive and complex machine learning model into an intuitively understandable format. The system speeds up decision-making at all levels from a management layer to a site worker. The system eliminates a time lag in information sharing. As a specific application field, the system is applied to a production management department of a global company that supervises a plurality of factories, and a management task of a large-scale construction project in which a daily progress report is indispensable.

Step 8: Reflection of site feedback and operation improvement. A site worker or a manager performs progress input, a comment, an improvement proposal, an abnormality report, uploading of a site photo/video, and the like from a terminal, the information is immediately reflected on the server, and the generative AI analyzes the site feedback to automatically generate an operation improvement plan and a company-wide sharing plan of site knowledge, and reflects them in optimization processing and a report from the next time onward. Specifically, the feedback processing unit receives multimodal data transmitted from a site terminal. The feedback processing unit inputs the received site photo data to a convolutional neural network. The feedback processing unit extracts a feature vector of a specific equipment state or work environment in the image. The feedback processing unit inputs a text comment input by the worker to a natural language processing model. The feedback processing unit calculates a sentiment polarity score of the text and an embedding vector of a keyword. The input data is a high-dimensional tensor combining the image feature vector and the text embedding vector. The feedback processing unit inputs this high-dimensional tensor to a clustering algorithm. The feedback processing unit groups similar site problems and improvement proposals. The output data is a center coordinate vector of each cluster and an importance score of the feedback belonging to the cluster. As a specific example of the output data, an importance score of a cluster regarding difficulty in using a specific tool is 0.8. An importance score of a cluster regarding safety of a specific work procedure is 0.95. The feedback processing unit dynamically adjusts a hyperparameter of an existing optimization model based on this analysis result. The feedback processing unit incorporates a site satisfaction score into a reward function of a reinforcement learning agent. The feedback processing unit periodically executes fine-tuning of the model. The feedback processing unit converts tacit knowledge of the site into explicit knowledge. The feedback processing unit registers the extracted knowledge in a company-wide knowledge base. As a technical effect, the system integrates not only top-down optimization but also bottom-up site knowledge into the system. The system continuously improves inference accuracy of the artificial intelligence model. The system dramatically enhances an adaptive capability of the system to an environmental change. As a specific application field, the system is applicable to a traditional manufacturing industry where inheritance of know-how of a skilled worker is an issue, and a continuous improvement activity in a plant construction site where a site situation changes daily.

### Specific Use Case

For example, when the factory robot management system of the present invention is applied to an assembly factory of automobile parts, robots having a plurality of functions such as welding, assembly, inspection, and conveyance, and workers assisting each process are arranged in the factory. Each robot is equipped with an operation state sensor, a temperature sensor, a vibration sensor, a current sensor, an image recognition camera, and the like, and the worker inputs progress and an abnormality using a tablet terminal or a wearable device. The robot operation status monitoring unit collects an operation state, a workload, a maintenance history, a failure occurrence status, and progress data in real time from these sensors and terminals, and extracts a sign of abnormality such as, for example, “an operation rate of a welding robot A has rapidly decreased in the latest 24 hours”, “a continuous operation time of an assembly robot B exceeds a specified value”, “an abnormal stop has occurred three times in an inspection robot C”, and “a continuous work time of a worker D is long and there is a sign of fatigue”. As a specific example of a prompt sentence to be read into the generative AI, “Analyze the following robot operation data, workload, maintenance history, failure occurrence status, and work progress data, and extract a sign of abnormality and an operation abnormality. If there is a sign of a decrease in operation rate or an abnormal stop, point it out and list robots requiring attention.” is given. Specifically, the robot operation status monitoring unit adopts a cooperative processing architecture of an edge server and a cloud server. The robot operation status monitoring unit acquires time-series data at a frequency of 1000 times per second from a multi-axis acceleration sensor installed at an arm joint of the welding robot. The robot operation status monitoring unit divides this time-series data by a sliding window method. The robot operation status monitoring unit converts the divided data into a 512-dimensional feature vector. The robot operation status monitoring unit inputs this feature vector to a one-dimensional convolutional neural network on the cloud. The one-dimensional convolutional neural network learns a temporal dependency. The one-dimensional convolutional neural network outputs a binary classification score determining whether a current state of each robot is normal or abnormal. The output data is a probability value in a range from zero to one. As a specific example of the output data, an abnormality probability of the welding robot A is 0.92. An abnormality probability of the assembly robot B is 0.85. A fatigue probability based on an analysis result of heart rate variability data acquired from the wearable device of the worker D is 0.88. The robot operation status monitoring unit immediately generates an alert signal when this probability score exceeds a threshold of 0.8. The robot operation status monitoring unit transmits this alert signal to an integrated monitoring and control system of the factory. The robot operation status monitoring unit simultaneously generates text data including a context of the abnormality. The robot operation status monitoring unit uses this text data as a prompt for a large language model. As a technical effect, the system processes massive stream data generated from a wide variety of sensors in real time. The system captures a minute change in an operation pattern that a human monitor cannot notice. The system prevents a serious equipment failure and an occupational accident in advance. As a specific application field, the system is extremely effective for equipment monitoring in a car body welding line of an automobile where hundreds of industrial robots operate synchronously, and a bottling factory of beverages operating at high speed.

The work allocation optimization unit comprehensively analyzes a skill set, a workload, an operation state, a maintenance history, a parts supply status, a task priority, a process progress, a site layout, a health condition and a vacation schedule of a worker, and the like of a robot and a worker having skills such as welding, assembly, inspection, and conveyance, and automatically generates an optimal allocation plan such as, for example, “allocate a welding task to a robot E having a high welding skill, currently operating, and having a low workload”, “allocate an assembly task to a robot G having a high assembly skill while avoiding a robot F requiring maintenance recently”, “preferentially allocate an inspection task to a worker H having abundant failure response experience”, “allocate a conveyance task to a robot I having the shortest flow line on the site layout”, “preferentially allocate a robot J having a high operation rate at night”, and “automatically generate a reasonable shift considering the health condition and the vacation schedule of a worker K”. As a specific example of a prompt sentence to be read into the generative AI, “Propose an optimal work allocation plan and scheduling based on the following robot/worker skill, operation state, workload, maintenance history, parts supply status, task priority, process progress, site layout, health condition, and vacation schedule.” is given. Specifically, the work allocation optimization unit implements a hybrid inference engine combining a solver of a constraint satisfaction problem and a graph attention network. The work allocation optimization unit models all tasks and all resources in the factory as a bipartite graph. The work allocation optimization unit allocates a feature vector including a required skill level and a deadline to each task node. The work allocation optimization unit allocates a feature vector including a current operation state and a skill set to each resource node. The input data is an adjacency matrix indicating a connection relationship between these node features and edges. The work allocation optimization unit inputs this graph data to the graph attention network. The graph attention network calculates a strength of relevance between nodes as an attention weight. The graph attention network outputs a fitness score of each resource for each task. The output data is a fitness matrix of rows of the number of tasks and columns of the number of resources. As a specific example of the output data, a fitness score of the robot E for the welding task is 0.95. A fitness score of the robot G for the assembly task is 0.91. A fitness score of the worker H for the inspection task is 0.89. The work allocation optimization unit inputs this fitness matrix to the constraint satisfaction problem solver. The solver searches for an optimal allocation combination that minimizes an overall task completion time while satisfying a hard constraint such as a maximum working time of a worker and a maintenance schedule of a robot. The work allocation optimization unit outputs the searched optimal allocation result as a data structure in a Gantt chart format. The work allocation optimization unit distributes this data to a control controller of each robot and a terminal of the worker. As a technical effect, the system derives a global optimal solution from millions of combinations in milliseconds under a dynamic environment where complex constraint conditions are intertwined. The system reduces an idle time of a resource to the utmost limit. The system maximizes a throughput of the factory. As a specific application field, the system is applied to dynamic scheduling in an automobile assembly line performing high-mix mixed-model production, and a cell production system factory of electronic equipment with severe demand fluctuation.

The maintenance management optimization unit analyzes an operation time, the number of days elapsed since the last maintenance, a failure occurrence history, a replacement parts history, a maintenance worker skill, a maintenance parts inventory, and the like of each robot, and automatically generates a maintenance plan such as, for example, “recommend maintenance for a robot L whose operation time exceeds a specified value”, “recommend emergency maintenance for a robot M in which failures frequently occur”, “recommend similar parts replacement for a robot N whose failure occurrence rate has decreased after specific parts replacement”, “allocate a person in charge considering a skill of a maintenance worker O”, and “automatically order replenishment when an inventory of a maintenance part P is insufficient”. As a specific example of a prompt sentence to be read into the generative AI, “Propose optimal maintenance timing, maintenance content, person in charge allocation, and parts replenishment plan based on the following robot operation time, maintenance history, failure occurrence history, replacement parts history, maintenance worker skill, and maintenance parts inventory.” is given. Specifically, the maintenance management optimization unit executes a machine learning model in which a random forest algorithm and a gradient boosting decision tree are ensembled. The maintenance management optimization unit extracts an operation log and a maintenance record over the past several years of each robot from a database. The maintenance management optimization unit preprocesses this data and generates a feature vector indicating a current state of each robot. The input data is a 64-dimensional numerical vector including an elapsed time since the last maintenance, an average temperature increase rate in the past month, an occurrence frequency of a specific vibration pattern, and the like. The maintenance management optimization unit inputs this feature vector to the ensemble model. The ensemble model performs majority voting inference by a plurality of decision trees. The ensemble model outputs a probability that each robot will cause a fatal failure within the next week. The output data is a list of pairs of an identifier of each robot and a failure probability score. As a specific example of the output data, a failure probability of the robot L is 85 percent. A failure probability of the robot M is 92 percent. A failure probability of the robot N is 12 percent. The maintenance management optimization unit immediately generates a maintenance task when this failure probability score exceeds a preset warning threshold. The maintenance management optimization unit transmits this maintenance task to the aforementioned work allocation optimization unit. The maintenance management optimization unit simultaneously specifies a part number and a quantity of a necessary replacement part. The maintenance management optimization unit collates this information with a parts inventory database. When the inventory is insufficient, the maintenance management optimization unit automatically executes an API call of an ordering request to a purchasing system. As a technical effect, the system realizes a paradigm shift from uniform periodic maintenance based on a rule of thumb to condition-based maintenance based on an actual deterioration state of each device. The system suppresses a cost increase due to excessive maintenance. The system completely prevents a stop of a production line due to a sudden failure. As a specific application field, the system is applicable to maintenance management of continuous casting equipment in a steelworks where a stop is not allowed, and a semiconductor manufacturing apparatus operating in a clean room.

The parts supply monitoring unit monitors a parts inventory, a consumption pace, a supply delay, quality data, supplier information, an ordering history, a delivery history, a lot number, an expiration date, a storage location, traceability information, and the like, and automatically generates a proposal such as, for example, “recommend replenishment when an inventory of a part Q becomes less than 10”, “recommend process adjustment when supply of a part R is delayed from a schedule”, “recommend advance replenishment because consumption of a part S increases on weekends”, “propose suspension of use of a corresponding lot and a claim to a supplier when a defect rate is increasing in a specific lot of a part T”, and “recommend priority consumption when an expiration date of a part U is near”. As a specific example of a prompt sentence to be read into the generative AI, “Propose a replenishment plan, an ordering plan, a supplier review plan, and a quality improvement plan based on the following parts inventory, consumption pace, supply delay, quality data, supplier information, ordering history, delivery history, lot number, expiration date, storage location, and traceability information.” is given. Specifically, the parts supply monitoring unit implements a transformer-based neural network specialized for time-series prediction. The parts supply monitoring unit integrates a past consumption history, seasonal fluctuation data, and production plan data of each part. The parts supply monitoring unit normalizes this integrated data and constructs a feature matrix for each time step. The input data is a three-dimensional tensor including a daily consumption amount for the past 180 days, a day-of-week category, and a promotion flag. The parts supply monitoring unit inputs this three-dimensional tensor to a transformer model. The transformer model learns both a long-term dependency and a short-term fluctuation pattern by a self-attention mechanism. The transformer model outputs a daily demand prediction value of each part for the next 30 days. The output data is a time-series vector indicating a predicted consumption amount for each part. As a specific example of the output data, a predicted consumption amount of the part Q for tomorrow is 50. A predicted consumption amount of the part R for the day after tomorrow is 100. A predicted consumption amount of the part S for the weekend is 300. The parts supply monitoring unit compares this predicted consumption amount vector with a current inventory level and an ordering lead time. The parts supply monitoring unit executes a dynamic ordering point calculation algorithm. The parts supply monitoring unit automatically generates a replenishment alert at a point in time when a risk that the inventory falls below a safety stock level exceeds 90 percent. The parts supply monitoring unit performs a correlation analysis between the quality data and the lot number. The parts supply monitoring unit detects that defects are concentrated in a specific lot by a statistical hypothesis test. The parts supply monitoring unit instructs an inventory management system to perform automatic lock processing of the corresponding lot. As a technical effect, the system breaks away from simple threshold-based inventory management. The system realizes proactive supply chain management based on advanced demand prediction. The system optimizes a trade-off between a production stop risk due to a shortage and a storage cost due to excess inventory. As a specific application field, the system is applied to an automobile assembly factory where tens of thousands of parts are supplied just-in-time, and a manufacturing and logistics base of apparel products with severe demand fluctuation.

The quality analysis unit multilaterally analyzes quality data, the number of defective product occurrences, an inspection result, a past quality trouble history, a parts supply history, an assignment history, an inter-process comparison, a quality cost, customer feedback, an audit result, an improvement activity history, and the like associated with each process or task, automatically generates an improvement plan such as, for example, “propose a review of a work procedure and retraining of a person in charge when defective products frequently occur in an assembly process”, “propose a traceability investigation of a parts lot and a quality improvement request to a supplier when defects are concentrated in a specific part in an inspection process”, “propose an inter-process quality comparison and a cost reduction plan when a quality cost is soaring”, and “propose a quality improvement activity from customer feedback”, and immediately notifies a quality warning and an improvement proposal. As a specific example of a prompt sentence to be read into the generative AI, “Propose identification of a quality problem, an improvement plan, a reassignment plan, a quality education plan, and a quality cost reduction plan based on the following quality data, number of defective product occurrences, inspection result, past quality trouble history, parts supply history, assignment history, inter-process comparison, quality cost, customer feedback, audit result, and improvement activity history.” is given. Specifically, the quality analysis unit constructs an inference pipeline combining a multilayer perceptron equipped with an attention mechanism and a natural language generation model. The quality analysis unit acquires manufacturing history data of each product from a manufacturing execution system. The quality analysis unit structures this data and generates a feature vector for each product. The input data is a 512-dimensional numerical vector including a lot number of a used part, an ID of a worker in charge of each process, an environmental temperature during processing, and a measurement value of an inspection device. The quality analysis unit inputs this numerical vector to the multilayer perceptron. The multilayer perceptron predicts a probability that the product will fail in a final inspection. The multilayer perceptron simultaneously outputs an attention weight. The output data is a defect occurrence probability score and an importance vector of an input feature that contributed most to the prediction. As a specific example of the output data, a defect occurrence probability of a certain product is 88 percent. A contribution degree of a parts lot A to the prediction is 0.6. A contribution degree of a worker B is 0.3. The quality analysis unit analyzes this importance vector. The quality analysis unit identifies whether a root cause of the defect is in a specific parts lot or in a procedure of a specific worker. The quality analysis unit collates this identification result with a past improvement activity history database. The quality analysis unit inputs an improvement action predicted to be most effective to the natural language generation model. The natural language generation model outputs a specific correction plan for a work procedure and a draft text of an improvement request to a supplier. The quality analysis unit automatically registers this text in a management system of a quality assurance department. As a technical effect, the system not only detects a defective product as a result, but also elucidates its occurrence mechanism from a correlation of high-dimensional data. The system eliminates a personalized cause investigation work. The system dramatically accelerates a quality improvement cycle. As a specific application field, the system is applicable to a semiconductor wafer manufacturing process in which an improvement in yield is a supreme proposition, and an aseptic filling line of pharmaceuticals in which mixing of a minute foreign substance is not allowed.

The report generation unit generates a detailed report summarizing an operation status of the entire factory, work progress, a maintenance status, a parts supply status, a quality status, an abnormality detection content, an optimization proposal, an improvement history, a cost analysis, an inter-process comparison, site feedback, a future prediction, and the like based on the AI analysis results of the respective units, and automatically distributes the detailed report including, for example, “operation rate transition for each robot”, “progress status for each task”, “maintenance execution history and future maintenance schedule”, “parts inventory transition and replenishment history”, “time-series transition of quality data”, “number of abnormality detections and response history”, “list of optimization proposals by AI”, “transition of quality cost”, “inter-process quality comparison”, “improvement proposal from site and its implementation status”, “future quality/operation prediction by AI”, and the like to a manager or a site supervisor. As a specific example of a prompt sentence to be read into the generative AI, “Create a report summarizing the operation status of the entire factory, progress, maintenance, parts supply, quality, abnormality, optimization proposal, improvement history, cost, inter-process comparison, feedback, and future prediction based on the following analysis results of the respective units.” is given. Specifically, the report generation unit executes a large language model system adopting a retrieval-augmented generation architecture. The report generation unit stores the latest inference result, time-series data, and alert log output from each subsystem in a vector database. When receiving a trigger for report generation, the report generation unit executes a semantic search on the vector database. The report generation unit extracts a highly relevant data chunk. The input data is a long context prompt extending to tens of thousands of tokens combining the extracted data chunks. As a specific example of the input data, statistical data that an operation rate of a robot A has decreased by 10 percent in the past week and prediction data that an inventory of a part B will be depleted tomorrow are included. The large language model processes this context prompt. The large language model understands a context using a decoder block of a transformer. The large language model outputs a hierarchical report text including a summary for a management layer and a specific action item for a site. The output data is a report object structured in a JSON format. As a specific example of the output data, today's factory operation summary is stored in a title field. An emergency inspection instruction for the robot A is stored in an action field. The report generation unit parses this report object. The report generation unit updates a component of a dynamic web dashboard. The report generation unit simultaneously transmits a push notification to a related party via an email or a business chat tool according to a set distribution rule. As a technical effect, the system integrates siloed data of each department and visualizes it as a single reliable information source. The system eliminates a massive administrative work time spent on data collection and report creation. The system supports rapid management decision-making based on data. As a specific application field, the system is applied to a headquarters of a multinational company globally developing a plurality of production bases, and a control room of a large-scale logistics center where real-time situation grasping is required.

As described above, the factory robot management system of the present invention can collect and integrate diverse data at a site in real time, automate work allocation, maintenance, parts supply, quality management, process improvement, company-wide sharing of site knowledge, and future prediction through multilayered analysis and optimization proposals by generative AI, and realize improvement in productivity and quality at the site, reduction in downtime and a defect rate, and reduction in human burden. Specifically, the present system is based on a distributed processing architecture that seamlessly links edge devices and cloud computing. The present system processes stream data generated in units of gigabytes per second from thousands of sensor nodes arranged in a factory. The present system drives an ensemble inference engine integrating a plurality of different artificial intelligence algorithms of deep learning, reinforcement learning, a graph neural network, and a large language model. The present system receives a high-dimensional multimodal tensor including from a physical sensor signal to a human natural language text as input data. The present system generates a control command for each device, an optimal scheduling matrix, and a human-understandable natural language report as output data. The present system feeds back these outputs to each actuator and information terminal in the factory in real time. The present system takes in a result of an executed action again as input data as subsequent processing. The present system forms a closed-loop continuous learning cycle. As a technical effect, the present system evolves factory operation, which has conventionally relied on human experience and intuition, into a data-driven and self-optimizable autonomous system. The present system finds a complex correlation undiscoverable by humans by non-linear calculation in a high-dimensional space, and derives a total optimal solution. The present system goes beyond mere automation of business, and maximizes information processing capability of computer technology itself in a manufacturing domain. As specific application fields, the present system functions as a core operating system in all advanced manufacturing and logistics bases, such as a state-of-the-art smart factory promoting Industry 4.0, a next-generation automated warehouse aiming for complete unmanned operation, and a continuous production plant for biopharmaceuticals requiring advanced quality management.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

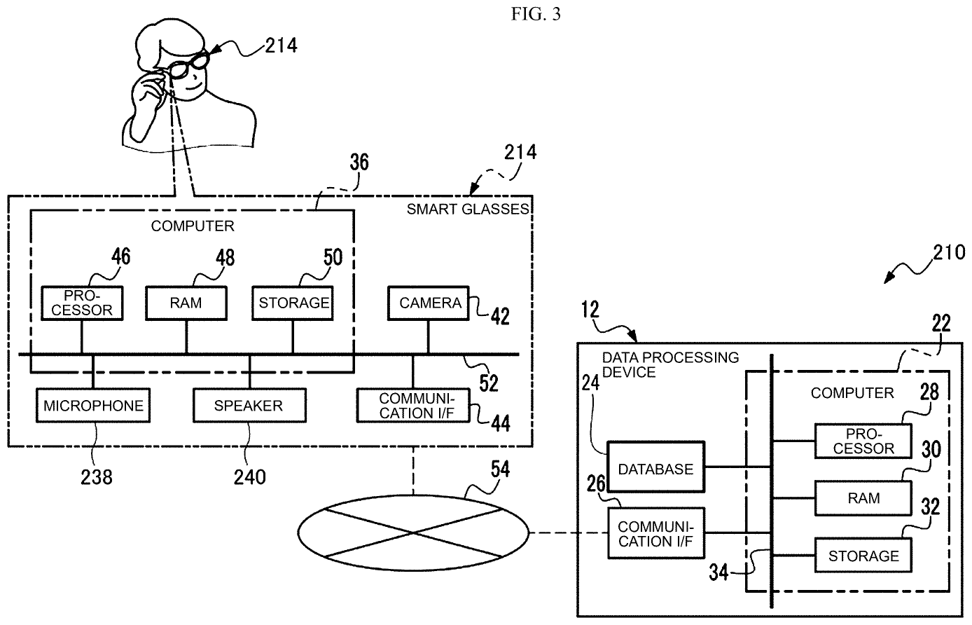

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

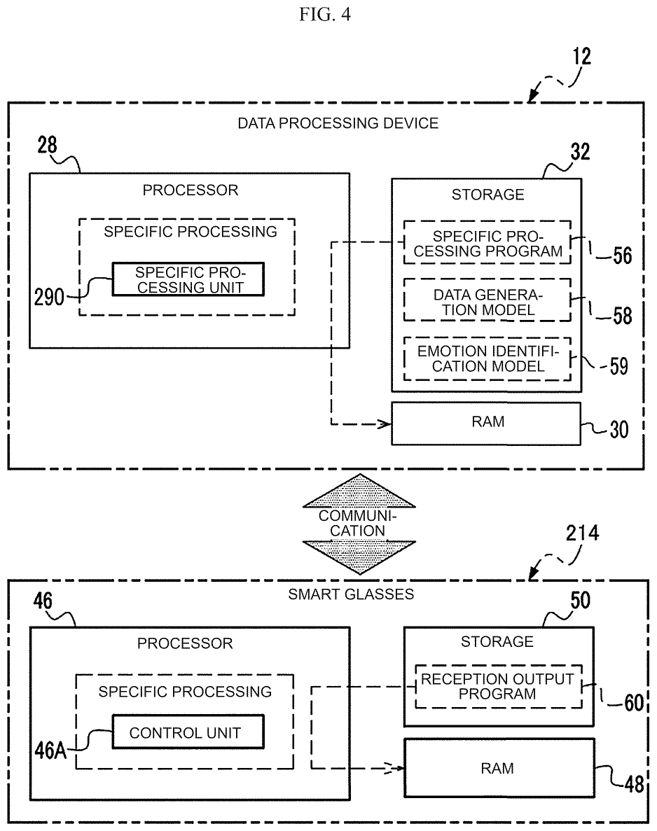

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

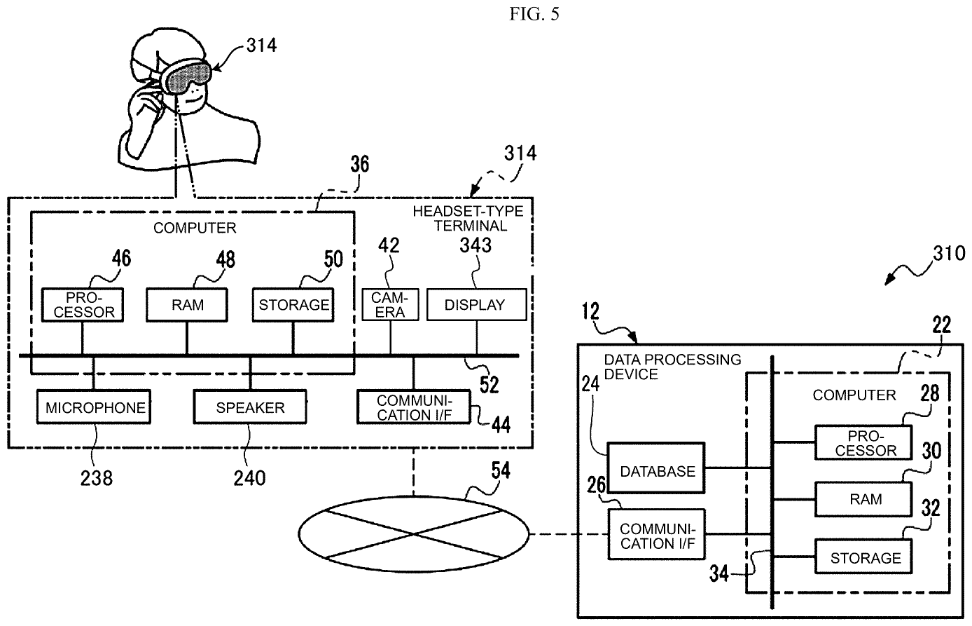

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

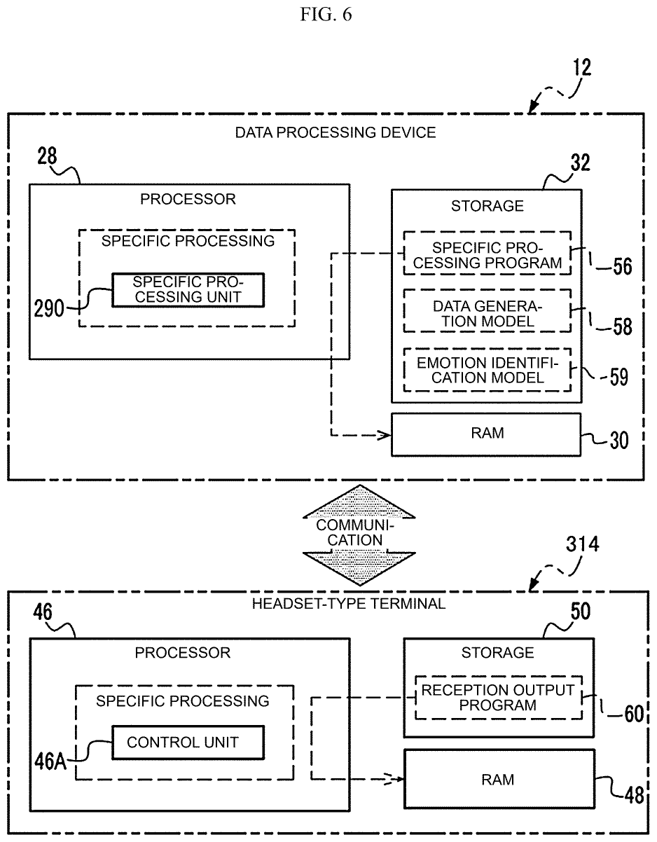

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

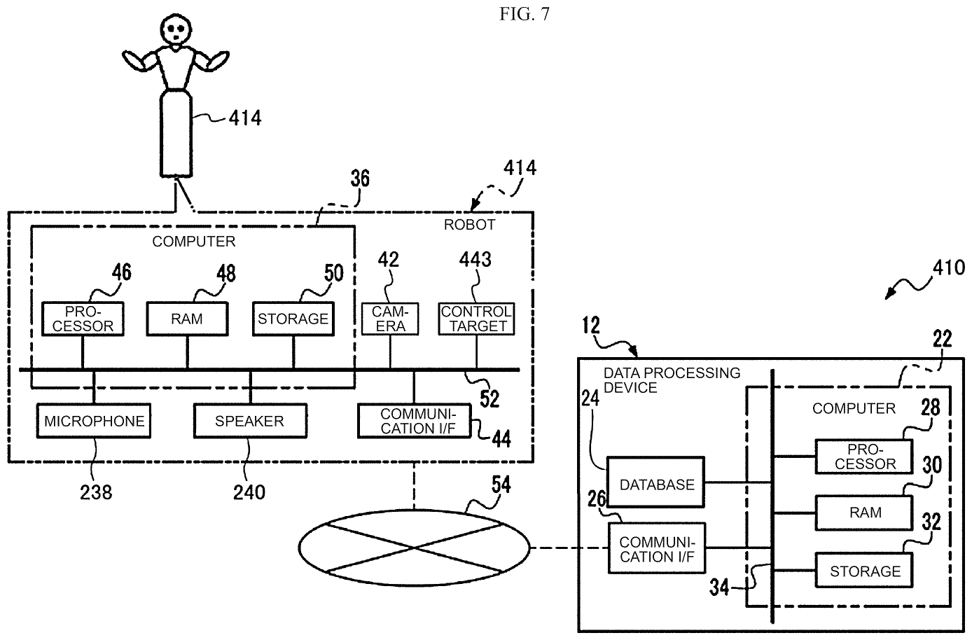

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

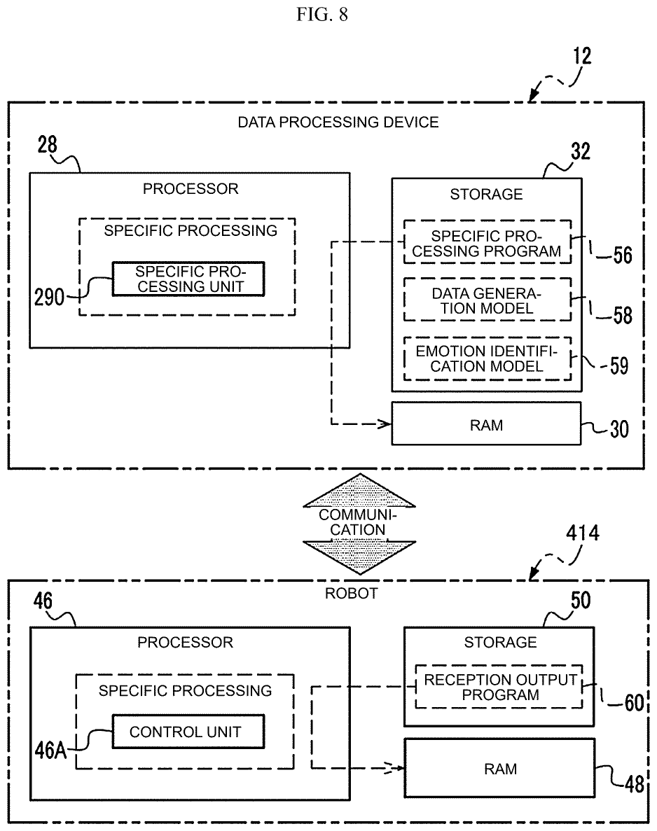

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

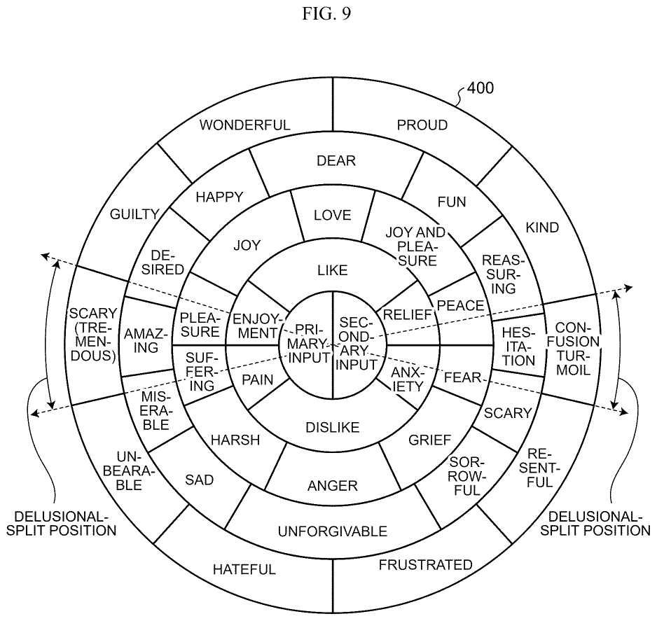

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

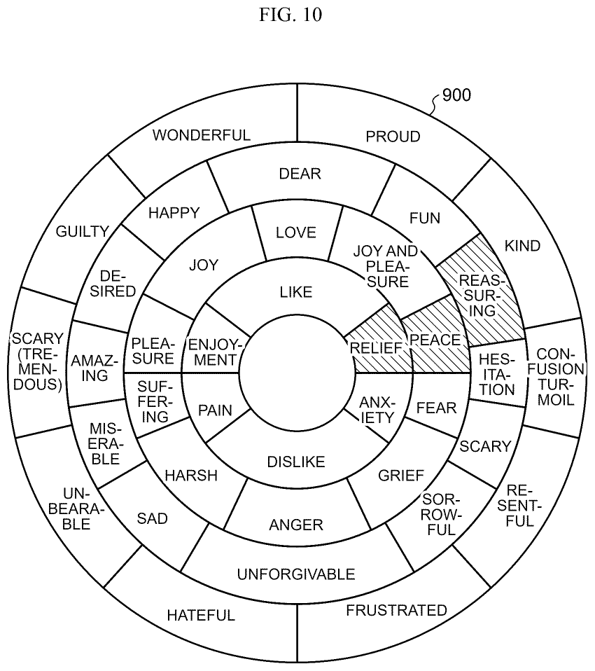

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.
(Supplementary Note 1) [0197] A factory robot management system comprising: a robot operation status monitoring unit; a work allocation optimization unit; a maintenance management optimization unit; a parts supply monitoring unit; a quality analysis unit; and a report generation unit, wherein the robot operation status monitoring unit has a function of collecting and analyzing information such as operation states, skills, workloads, maintenance histories, failure occurrence statuses, and work progresses of a plurality of robots and workers in a factory in real time using generative AI, and automatically detecting a sign of abnormality and an operation abnormality; the work allocation optimization unit has a function of comprehensively analyzing the data acquired by the robot operation status monitoring unit and the skill, workload, operation state, maintenance history, parts supply status, task priority, and process progress of each robot by the generative AI, automatically determining optimal work allocation and operation scheduling, and performing task reallocation and an operation stop/restart instruction of the robot as necessary; the maintenance management optimization unit has a function of analyzing an operation time, the number of days elapsed since the last maintenance, a failure occurrence history, and an operation pattern of each robot by the generative AI, and performing automatic proposal of maintenance timing, recommendation of preventive maintenance, and immediate alert transmission at the time of a sign of abnormality; the parts supply monitoring unit has a function of monitoring and analyzing an inventory status, a consumption pace, a supply delay, and quality data for each part by the generative AI, and performing a replenishment proposal at the time of inventory shortage, an automatic ordering instruction, and alert transmission at the time of supply abnormality; the quality analysis unit has a function of analyzing quality data, the number of defective product occurrences, an inspection result, and a past quality trouble history associated with each process or task by the generative AI, and performing early detection of a quality problem and automatic presentation of a process improvement plan; and the report generation unit has a function of generating a detailed report including an operation status of the entire factory, work progress, a maintenance status, a parts supply status, a quality status, an abnormality detection content, and an optimization proposal based on analysis results of the respective units, and automatically distributing the detailed report to a manager or a site supervisor.
(Supplementary Note 2) [0198] The factory robot management system according to Supplementary Note 1, wherein the work allocation optimization unit comprehensively analyzes a skill set, an operation state, a workload, a maintenance history, a task priority, a parts supply status, a process progress, and a failure occurrence status of each robot and worker using the generative AI, automatically performs optimal work allocation to an optimal robot or worker starting from a task with high priority, executes recalculation of allocation and reallocation in real time according to a progress of an ongoing task and a change in a site situation, and realizes flexible scheduling including operation stop/restart of the robot and reassignment of the worker as necessary.
(Supplementary Note 3) [0199] The factory robot management system according to Supplementary Note 1, wherein the quality analysis unit multilaterally analyzes quality data, the number of defective product occurrences, an inspection result, a past quality trouble history, a parts supply history, and an assignment history of a worker or a robot associated with each process or task using the generative AI, identifies a process or a person in charge where defects frequently occur, automatically proposes early detection of a quality problem, a process improvement plan, a reassignment plan for the person in charge, and a review plan for a parts supply route, and further immediately notifies a manager or a site supervisor of a quality warning and an improvement proposal through the report generation unit.

What is claimed is:

1. A system comprising:
circuitry configured to:
receive, via a communication interface coupled to a packet-switched network, streaming sensor data from sensor devices in a manufacturing facility at a high sampling frequency, convert the streaming sensor data into a multidimensional tensor, and store the multidimensional tensor in a storage device;
apply a large language model and a neural network for time-series prediction to the multidimensional tensor to generate a task state analysis data record comprising a progress deviation score for each task identifier and a predicted completion time vector;
apply a resource allocation optimization model to the task state analysis data record and a skill parameter record and workload parameter record associated with each available personnel identifier to generate a task assignment data record comprising an optimized task-to-personnel mapping;
generate a progress report data record from the task state analysis data record using the large language model by applying autoregressive decoding to produce a structured natural language summary; and
transmit the task state analysis data record, the task assignment data record, and the progress report data record to terminal devices via the communication interface.

2. The system according to claim 1, wherein the circuitry is configured to acquire streaming sensor data from various sensor groups in the manufacturing facility via an asynchronous data collection protocol, convert the acquired data into a multidimensional tensor, and expand the converted tensor in memory for asynchronous processing by the large language model and time-series prediction neural network.

3. The system according to claim 2, wherein the circuitry is configured to distribute the multidimensional tensor to a plurality of computing nodes in a parallel computing cluster, execute large language model inference and time-series prediction in parallel across the computing nodes, and asynchronously return analysis results to a central aggregation module.

4. The system according to claim 1, wherein the circuitry is configured to apply the neural network for time-series prediction to the multidimensional tensor by applying a one-dimensional convolutional neural network to extract frequency-domain features and a long short-term memory network to generate multi-step ahead prediction values, and compute the predicted completion time vector from the prediction values.

5. The system according to claim 4, wherein the circuitry is configured to compute the progress deviation score for each task identifier by comparing the predicted completion time value against a temporal constraint parameter, generate a deviation alert when a progress deviation score exceeds a deviation threshold, and incorporate the deviation alert as a priority flag in the task assignment data record.

6. The system according to claim 1, wherein the circuitry is configured to apply a graph neural network to a task dependency graph comprising task identifier nodes and prerequisite constraint edges, execute message passing operations to propagate deadline pressure scores across connected task nodes, and identify critical path task identifiers as high-priority entries in the resource allocation optimization model.

7. The system according to claim 6, wherein the circuitry is configured to apply the resource allocation optimization model to solve a constraint satisfaction problem assigning critical path task identifiers to personnel identifiers having compatible skill parameter records and available workload capacity, and generate an optimized task-to-personnel mapping minimizing total expected completion time.

8. The system according to claim 1, wherein the circuitry is configured to receive status update records from terminal devices via the communication interface indicating task completion or delay events, update corresponding task state records in the storage device, regenerate the task state analysis data record incorporating the updated task states, and regenerate the task assignment data record if reassignment is needed.

9. The system according to claim 1, wherein the circuitry is configured to apply a predictive maintenance model to the multidimensional sensor tensor to compute degradation trend metrics for manufacturing equipment, generate a maintenance alert data record when a predicted degradation trend exceeds a maintenance threshold, and incorporate the maintenance alert into the task assignment data record as a maintenance task entry.

10. The system according to claim 1, wherein the circuitry is configured to apply the large language model to generate natural language explanations for each resource allocation decision in the task assignment data record, retrieve relevant historical case records from a vector database by cosine similarity search for inclusion as reference context, and incorporate the explanations in the progress report data record.

11. The system according to claim 1, wherein the circuitry is configured to apply a resource inventory management model to resource count data records in the storage device to compute availability indicators for each resource category, generate a resource constraint alert when a resource availability indicator falls below a minimum threshold, and incorporate resource constraint alerts in the task assignment data record.

12. The system according to claim 1, wherein the circuitry is configured to generate a visualization data record from the task state analysis data record comprising a Gantt chart data structure showing task timelines and dependency relationships, and transmit the visualization data record to terminal devices for display on a management dashboard.

13. The system according to claim 1, wherein the circuitry is configured to apply a comparative analysis model to the task state analysis data record and historical task performance records retrieved from the storage device, compute a relative performance index for current task execution against historical baselines, and incorporate the relative performance index in the progress report data record.

14. The system according to claim 1, wherein the circuitry is configured to update the large language model and the neural network for time-series prediction by generating training pairs from historical multidimensional tensors and corresponding validated task completion outcome records, and fine-tune both models to improve prediction accuracy for specific sensor data pattern and task type combinations.

15. The system according to claim 1, wherein the circuitry is configured to schedule automated progress report data record generation at configurable intervals, apply the large language model to the most recently available task state analysis data record, and transmit the generated progress report to terminal devices associated with designated recipient user identifiers.

16. The system according to claim 1, wherein the circuitry is configured to enforce a role-based access control policy by verifying a user role parameter before permitting access to task state analysis data records or task assignment data records, and apply data minimization to return only fields authorized for the requesting user role.

17. The system according to claim 1, wherein the sensor devices are distributed across a manufacturing facility, the multidimensional tensor represents streaming equipment state data from the facility, and the task state analysis data record represents operational status assessments of manufacturing tasks derived from the sensor data.

18. A system comprising:
circuitry configured to:
receive, via a communication interface coupled to a packet-switched network, streaming sensor data from manufacturing facility sensors, convert it to a multidimensional tensor, and distribute it to a parallel computing cluster;
apply a large language model and a one-dimensional convolutional neural network with long short-term memory network to generate progress deviation scores and predicted completion time vectors;
apply a graph neural network to a task dependency graph to identify critical path tasks, and apply a resource allocation optimization model to generate optimized task assignment data records;
generate progress report data records using the large language model with retrieval-augmented generation; and
transmit task state analysis records, assignment records, and progress reports to terminal devices via the communication interface.

19. The system according to claim 18, wherein the circuitry is configured to apply a predictive maintenance model to generate maintenance alert data records incorporating into task assignments, apply a comparative analysis model to compute relative performance indices against historical baselines, and apply a resource inventory management model to generate resource constraint alerts.

20. A method comprising:
receiving, via a communication interface coupled to a packet-switched network, streaming sensor data from sensor devices in a manufacturing facility, converting to a multidimensional tensor, and storing in a storage device;
applying a large language model and a neural network for time-series prediction to generate a task state analysis data record comprising progress deviation scores and predicted completion time vectors;
applying a resource allocation optimization model to generate a task assignment data record;
generating a progress report data record using the large language model; and
transmitting the task state analysis data record, task assignment data record, and progress report data record to terminal devices via the communication interface.
